(19) United States
(12) Patent Application Publication
(10) Pub. No.: US 2007/0052641 A1
(43) Pub. Date: Mar. 8, 2007

(54) Gray scale voltage outputting device

(75) Inventors: Shuji Hagino, Nishi-ku (JP); Masaru Yasui, Nishi-ku (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/540,066

(22) PCT Filed: Dec. 22, 2003
(86) PCT No.: PCT/IB03/06219

§ 371 Date: Jun. 22, 2005

(30) Foreign Application Priority Data
Dec. 27, 2002 (JP) 2002-382426

(51) Int. Cl. G09G 3/36

(52) U.S. Cl. 345/89

(57) ABSTRACT

An object of the invention is to provide the miniaturized gray scale voltage outputting device. A gray scale voltage outputting device (6) for receiving an image signal (Si) to output a gray scale voltage comprises a gray scale voltage group outputting means (600) having a plurality of gray scale voltage group outputting portions, each of which outputs a gray scale voltage group having a plurality of gray scale voltages in such a way that said plurality of gray scale voltages are sequentially outputted from said respective gray scale voltage group outputting portions during an gray scale voltage group outputting period (Pv) corresponding to a selection period of a source bus (Bs), a selector (62), having a plurality of gray scale voltage group inputting portions (In1 to In32) for receiving said gray scale voltage groups (G1 to G32) outputted from said plurality of gray scale voltage group outputting portions (Out1 to Out32), for selecting from said gray scale voltage groups (G1 to G32) received by said plurality of gray scale voltage group inputting portions (In1 to In32) to output said selected gray scale voltage group and a switch (63) for selecting, from said plurality of gray scale voltages comprised by said gray scale voltage group outputted from the selector (62), a gray scale voltage which is to be outputted from said gray scale voltage outputting device.

### BACKGROUND OF THE INVENTION

1. Field of the Invention

The invention relates to a gray scale voltage outputting device for receiving an image signal having a plurality of image data to output a gray scale voltage.

2. Description of Related Art

In recent years, mobile devices displaying color images, such as mobile phones, spread fast, it is needed to display images having more multiple gray scale levels accordingly.

For the purpose of displaying an image having more multiple gray scale levels, a gray scale voltage outputting device is required which can generate more multiple gray scale voltages and then output one of the generated gray scale voltages corresponding to the image data. Therefore, the area occupied by the gray scale voltage outputting device increases as the number of the gray scale voltages to be generated increases, so that the problem of the difficulty of the miniaturization of the mobile device arises.

### SUMMARY OF THE INVENTION

It is an object of the invention to provide the miniaturized gray scale voltage outputting device.

The gray scale voltage outputting device according to the present invention for achieving the object described above is a gray scale voltage outputting device for outputting gray scale voltages in response to an image signal having a plurality of image data, wherein said device comprises a first selecting means, having a plurality of first inputting portions for receiving a plurality of gray scale voltage groups each of which has a plurality of gray scale voltages, for selecting one of said received plurality of gray scale voltage groups, and wherein said device outputs one or more gray scale voltages of said plurality of gray scale voltages of said selected gray scale voltage group.

The gray scale voltage outputting device according to the present invention is provided with the first selecting means having the plurality of first inputting portions. The plurality of first inputting portions receive the plurality of gray scale voltage groups each of which having a plurality of gray scale voltages, so that each of the first inputting portions can receive the plurality of gray scale voltages. Therefore, the required number of first inputting portions of the first selecting means can be smaller than the total number of gray scale voltages, so that the miniaturization of the first selecting means is achieved.

The gray scale voltage outputting device according to the present invention may comprise a first outputting means having a plurality of first outputting portions for outputting said plurality of gray scale voltage groups to said plurality of first inputting portions of said first selecting means during a first predetermined period.

Each of the plurality of first outputting portions of the first outputting means outputs the plurality of gray scale voltages. Therefore, the required number of first outputting portions of the first outputting means can be smaller than the total number of gray scale voltages, so that miniaturization of the first outputting means is achieved.

In the gray scale voltage outputting device according to the present invention, said first outputting means may comprise a generating means for generating said plurality of gray scale voltage groups, and wherein said generated plurality of gray scale voltage groups are outputted from said plurality of first outputting portions of said first outputting means during said first predetermined period.

In the gray scale voltage outputting device according to the present invention, said image data may be represented by a plurality of bits, and wherein the total number of said gray scale voltages of said generated plurality of gray scale voltage groups may be equal to the number of bit patterns which said plurality of bits can take.

In the gray scale voltage outputting device according to the present invention, said first selecting means may select one of said received plurality of gray scale voltage groups on the basis of a bit pattern of higher order bits of said plurality of bits, said higher order bits comprising at least the most significant bit of said plurality of bits, and wherein said device may output one or more gray scale voltages of said plurality of gray scale voltages of said selected gray scale voltage group on the basis of a bit pattern of lower order bits of said plurality of bits, said lower order bits comprising at least the least significant bit of said plurality of bits.

With such construction, the gray scale voltage outputting device can output the gray scale voltage corresponding to the image data.

In the gray scale voltage outputting device according to the present invention, said image data may be represented by a plurality of bits, and wherein the total number of said gray scale voltages of said plurality of gray scale voltage groups may be smaller than the number of bit patterns which said plurality of bits can take.

In the gray scale voltage outputting device according to the present invention, said first outputting means may comprise a second selecting means, having a plurality of second inputting portions for receiving a plurality of reference voltage group each of which has a plurality of reference voltages, for selecting two of said received plurality of reference voltage groups, and wherein said first outputting means may output said plurality of gray scale voltage groups from said plurality of first outputting portions on the basis of said selected two reference voltage groups.

In the gray scale voltage outputting device according to the present invention, said second selecting means may select said two reference voltage groups on the basis of a bit pattern of higher order bits of said plurality of bits, said higher order bits comprising at least the most significant bit of said plurality of bit s, wherein said first selecting means may select one of said received plurality of gray scale voltage groups on the basis of a bit pattern of intermediate order bits of said plurality of bits, and wherein said device may output one or more gray scale voltages of said plurality of gray scale voltages of said selected gray scale voltage group on the basis of a bit pattern of lower order bits of said plurality of bits, said lower order bits comprising at least the least significant bit of said plurality of bit s.

With such construction, the gray scale voltage outputting device can output the gray scale voltage corresponding to the image data.

In the gray scale voltage outputting device according to the present invention, it is preferable that at least one of said plurality of reference voltage groups is used as said gray scale voltage group.

If the gray scale voltage group is used as the reference voltage group, the gray scale voltage group outputting device can be more miniaturized.

In the gray scale voltage outputting device according to the present invention, said first outputting means may comprise a second outputting means having a plurality of second outputting portions for outputting said plurality of reference voltage groups to said plurality of second inputting portions of said second selecting means during a second predetermined period.

Each of the plurality of second outputting portions of the second outputting means outputs the plurality of reference voltages. Therefore, the required number of second outputting portions of the second outputting means can be smaller than the total number of reference voltages, so that miniaturization of the second outputting means is achieved.

The gray scale voltage outputting device according to the present invention may comprise a third selecting means for selecting one or more gray scale voltages of said plurality of gray scale voltages of said selected gray scale voltage group. In this case, said first selecting means sequentially may output said plurality of gray scale voltages of said selected gray scale voltage group to said third selecting means, and wherein said third selecting means may select a first gray scale voltage of said plurality of gray scale voltages and dose not select a second gray scale voltage of said plurality of gray scale voltages, said first gray scale voltage corresponding to said bit pattern of said lower order bits and said second gray scale voltage being outputted from said first selecting means after said first gray scale voltage.

With such third selecting means, the outputting device can output the gray scale voltage corresponding to the image data.

In the gray scale voltage outputting device according to the present invention, said third selecting means may also select a third gray scale voltage of said plurality of gray scale voltages, said third gray scale voltage being outputted from said first selecting means before said selected first gray scale voltage.

Even if the third selecting means also selects the third gray scale voltage outputted from said first selecting means before said selected first gray scale voltage, the device can output the desired gray scale voltage corresponding to the image data.

In the gray scale voltage outputting device according to the present invention, said first predetermined period may comprise a first sub-period and a second sub-period, said first sub-period being for outputting a gray scale voltage corresponding to said image data having the least significant bit of a first logic, said second sub-period being for outputting a gray scale voltage corresponding to said image data having the least significant bit of a second logic. In this case, it is preferable that the first sub-period may precedes said second sub-period and that the first sub-period is longer than said second sub-period since it is possible to display an image having a higher quality.

In the gray scale voltage outputting device according to the present invention, a first gray scale voltage group of said plurality of gray scale voltage group may comprise a smaller gray scale voltage than a predetermined ideal gray scale voltage during a first frame period of successive frame periods, wherein a second gray scale voltage group of said plurality of gray scale voltage group may comprise a higher gray scale voltage than said predetermined ideal gray scale voltage during a second frame period of said successive frame periods, wherein said first selecting means may select said first gray scale voltage group during said first frame period and selects said second gray scale voltage group during said second frame period, and wherein said device may output said smaller gray scale voltage if said first selecting means selects said first gray scale voltage group and outputs said higher gray scale voltage if said first selecting means selects said second gray scale voltage group.

With such construction, an image having a higher quality can be displayed using successive frame periods.

In the gray scale voltage outputting device according to the present invention, said device may comprise a processing means for processing a series of image data each of which having a predetermined bit pattern, wherein said processing means may output said series of image data as a series of outputting data comprising a first outputting data and a second outputting data, said first outputting data having said predetermined bit pattern and said second outputting data having a different bit pattern from said predetermined bit pattern, and wherein said device may output said smaller gray scale voltage during said first frame period and outputs said higher gray scale voltage during said second frame period on the basis of said series of outputting data.

With such construction, the device can output said smaller gray scale voltage during said first frame period and outputs said higher gray scale voltage during said second frame period.

In the gray scale voltage outputting device according to the present invention, said first selecting means may select one of said first and second gray scale voltage groups on the basis of a bit pattern of higher order bits of a first plurality of bits and may select the other of said first and second gray scale voltage groups on the basis of a bit pattern of higher order bits of a second plurality of bits, said first plurality of bits representing said first outputting data, said second plurality of bits representing said second outputting data

With such construction, the first selecting means can select both the first and second gray scale voltage groups.

In the gray scale voltage outputting device according to the present invention, a third gray scale voltage group of said plurality of gray scale voltage groups may comprise a predetermined gray scale voltage deviating from said predetermined ideal gray scale voltage, wherein said device may comprise an additional voltage outputting means for outputting an additional gray scale voltage deviating from said predetermined ideal gray scale voltage, wherein one of said predetermined gray scale voltage and said additional gray scale voltage may be larger than said predetermined ideal gray scale voltage and the other may be smaller than said predetermined ideal gray scale voltage, and wherein said device outputs said predetermined gray scale voltage during one of said first and second frame periods and may output said additional gray scale voltage during the other of said first and second frame periods on the basis of said series of outputting data. In this case it is preferable that said predetermined gray scale voltage is maximum gray scale voltage or minimum gray scale voltage.

With such construction, an image corresponding to the maximum gray scale voltage or the minimum gray scale voltage can be displayed with higher quality.

### BRIEF DESCRIPTION OF THE DRAWINGS

FIG. 1 is a schematic block diagram of the liquid crystal display device 1.

FIG. 2 is a schematic diagram of the outputting device 6 in the liquid crystal display device 1 shown in FIG. 1.

FIG. 3 is a graph showing the gray scale voltage groups G1 to G32 outputted from the outputting portions Out1 to Out32 of the outputting means 600.

FIG. 4 is a schematic diagram of the gray scale voltage outputting device 6 according to the second embodiment.

FIG. 5 is a graph showing the reference voltage groups Ga to Gi outputted from the outputting portions OutA to OutI of the outputting stage 701 shown in FIG. 4.

FIG. 6 is a graph showing one example of the gray scale voltage groups outputted from 4 outputting portions Out1 to Out4 of the outputting means 700, respectively. FIG. 7 shows a V-T curve C representing a V-T characteristic of the display portion 2.

FIG. 8 is a schematic diagram of the gray scale voltage outputting device 6 according to the third embodiment.

FIG. 9 is a graph showing voltages outputted from the outputting portions Out1 to Out32 and OutADD of the outputting means 800.

### DESCRIPTION OF THE PREFERRED EMBODIMENTS

The present invention is described below using the example in which the gray scale voltage outputting device of the present invention is applied to the liquid crystal display device, but the gray scale voltage outputting device can be applied to the image display device other than the liquid crystal display device.

### A First Embodiment

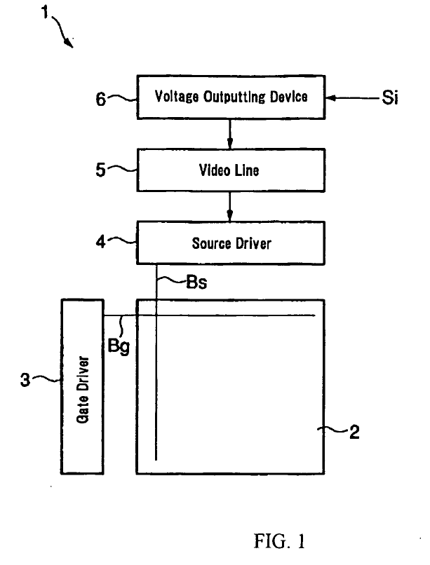

In the first embodiment, the example is described in which an liquid crystal display device 1 shown in FIG. 1 can provide 64-level gray scale by outputting two gray scale voltages from each of 32 outputting portions Out1 to Out 32 of an gray scale voltage group outputting means 600.

FIG. 1 is a schematic block diagram of the liquid crystal display device 1.

The liquid crystal display device 1 comprises a gray scale voltage outputting device 6. The outputting device 6 receives image signal Si having image data of 6 bits. When the outputting device 6 receives the image signal Si, the outputting device 6 outputs gray scale voltages representing bit patterns of the image data of the image signal Si. The outputted gray scale voltages from the outputting device 6 are supplied to respective pixel of a display portion 2 through a video line 5, a source driver 4 and a source bus Bs, so that the display portion 2 displays the image.

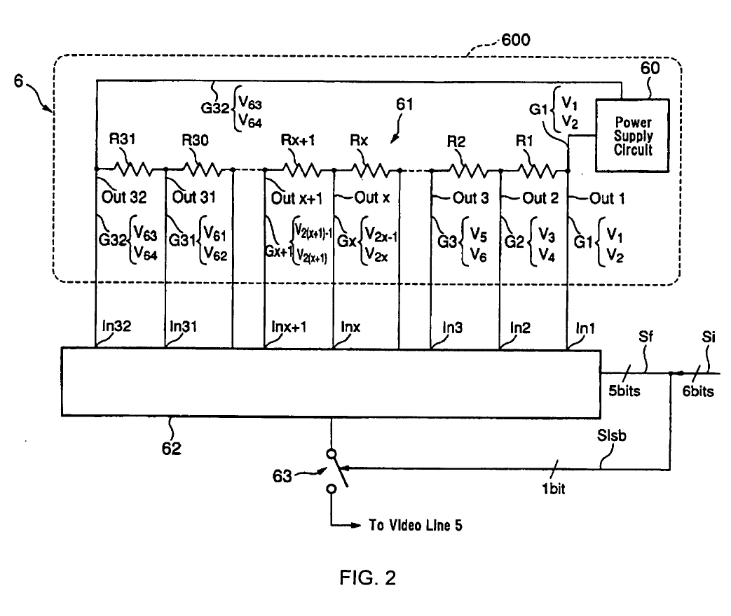

FIG. 2 is a schematic diagram of the outputting device 6 in the liquid crystal display device 1 shown in FIG. 1.

The outputting device 6 is provided with an outputting means 600 which can generate 64-level gray scale voltages V1 to V64. The outputting means 600 comprises 32 gray scale voltage group outputting portions Out1 to Out32. Furthermore, the outputting means 600 is provided with a power supply circuit 60 and a resistor chain 61 comprising resistors R1 to R31 in series. The voltages generated by using the power circuit 60 and the resistor chain 61 are outputted from the outputting portions Out1 to Out32 of the outputting means 600.

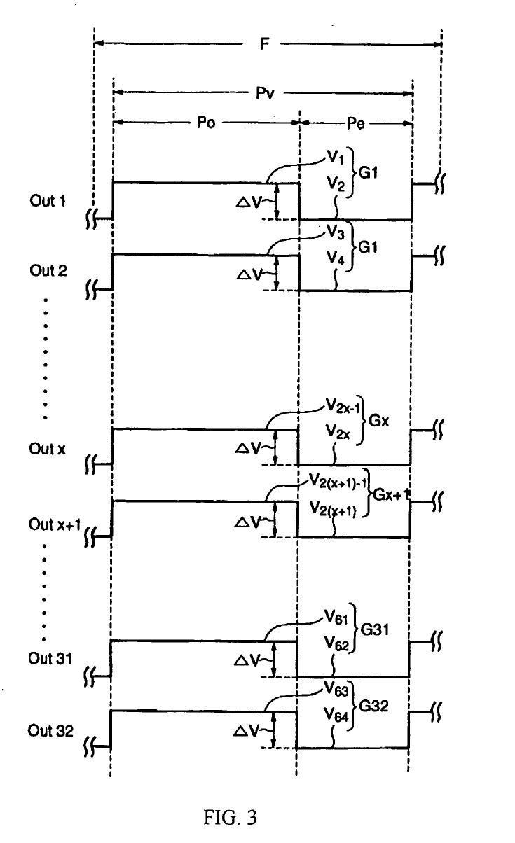

FIG. 3 is a graph showing the gray scale voltage groups G1 to G32 outputted from the outputting portions Out1 to Out32 of the outputting means 600. FIG. 3 schematically shows, in a frame period F, voltage wave forms of the gray scale voltage groups G1 to G32 which are outputted from the outputting portions Out1 to Out32 during a gray scale voltage group outputting period Pv corresponding to one selection period Ps for the source bus. In FIG. 3, it is noted that, for the sake of convenience, the voltage values of the gray scale voltage groups G1 to G32 are shown as absolute values of the differences from the value of voltage supplied to a common electrode (not shown) of the display portion 2.

The power supply circuit 60 (see FIG. 2) of the outputting means 600 generates the gray scale voltage groups G1 and G32. The gray scale voltage group G1 comprises the gray scale voltages V1 and V2 and the gray scale voltage group G32 comprises the gray scale voltages V63 and V64. The gray scale voltage group G1 is outputted from the outputting portions Out1 of the outputting means 600 during the outputting period Pv and the gray scale voltage group G32 is outputted from the outputting portions Out32 of the outputting means 600 during the outputting period Pv. The outputting period Pv is divided into an odd gray scale period Po and an even gray scale period Pe. The gray scale voltage V1 of the gray scale voltage group G1 is outputted during the odd gray scale period Po and the gray scale voltage V2 is outputted during the even gray scale period Pe. Furthermore, the gray scale voltage V63 of the gray scale voltage group G32 is outputted during the odd gray scale period Po and the gray scale voltage V64 is outputted during the even gray scale period Pe. The gray scale voltage V2 is defined so as to be smaller than the gray scale voltage V1 by ΔV and the gray scale voltage V64 is also defined so as to be smaller than the gray scale voltage V63 by ΔV.

The generated gray scale voltage groups G1 and G32 from the power supply circuit 60 are outputted from the outputting portions Out1 and Out32 of the outputting means 600 and are applied across the resistor chain 61. By applying the gray scale voltage groups G1 and G32 across the resistor chain 61, the resistor chain 61 generates the gray scale voltage groups G2 to G31. The generated gray scale voltage groups G2 to G31 are outputted from the outputting portions Out2 to Out31 of the outputting means 600. Therefore, the outputting means 600 can output the gray scale voltage groups G1 to G32 from the outputting portions Out1 to Out32. In the odd gray scale period Po, the gray scale voltages V1 and V63 are applied across the resistor chain 61, so that the resistor chain 61 generates gray scale voltages V3, V5, . . . , V59 and V61 between the gray scale voltages V1 and V63. Therefore, 32 gray scale voltages V2n−1 (n=1, 2, . . . , x, x+1, . . . , 32) of odd levels are outputted from the outputting portions Out1 to Out32 of the outputting means 600. That is to say, in the odd gray scale period Po, half of 64-level gray scale voltages (i.e. gray scale voltages V2n−1) are only outputted.

On the other hand, in the even gray scale period Pe, the gray scale voltages V2 and V64 are applied across the resistor chain 61, so that the resistor chain 61 generates gray scale voltages V4, V6, . . . , V60 and V62 between the gray scale voltages V2 and V64. Therefore, 32 gray scale voltages V2n (n=1, 2, . . . , x, x+1, . . . , 32) of even levels are outputted from the outputting portions Out1 to Out32 of the outputting means 600.

As described above, the gray scale voltage V2 outputted from the outputting portions Out1 during the even gray scale period Pe is defined so as to be smaller than the gray scale voltage V1 outputted during the odd gray scale period Po by ΔV. The gray scale voltage V64 outputted from the outputting portions Out32 during the even gray scale period Pe is also defined so as to be smaller than the gray scale voltage V63 outputted during the odd gray scale period Po by ΔV. Therefore, gray scale voltages outputted from the other outputting portions Out during the even gray scale period Pe are smaller than the gray scale voltages outputted during the odd gray scale period Po by ΔV, respectively. The value ΔV is selected in such a way that the gray scale voltage V2x of even level is located between the gray scale voltages V2x−1 and V2(x+1)−1 of odd levels. Therefore, each of the outputting portions Out1 to Out32 outputs two gray scale voltages during the outputting period Pv. As a result, the number of the outputting portions Out1 to Out32 of the outputting means 600 is 32, but the outputting means 600 can output all of 64-level gray scale voltages by the time when the outputting period Pv is concluded.

The outputting device 6 is provided with a selector 62. The selector 62 is provided with 32 gray scale voltage group inputting portions In1 to In32 corresponding to 32 outputting portions Out1 to Out32 of the outputting means 600. The outputted gray scale voltage groups G1 to G32 from 32 outputting portions Out1 to Out32 of the outputting means 600 are inputted to the corresponding inputting portions In1 to In32 of the selector 62. The selector 62 receives a higher order bits signal Sf representing higher order 5 bits FHB (Five Highmost Bits) which contain a most significant bit MSB of 6 bits image data. The selector 62 selects one of 32 inputting portions In1 to In32 corresponding to a bit pattern of the higher order 5 bits represented by the higher order bits signal Sf and then outputs the gray scale voltage group inputted to the selected inputting portion. Since the higher order bits signal Sf can take 32 (=25) bit patterns, the selector 62 is allowed to select each of 32 inputting portions In1 to In32 in accordance with the bit pattern of the higher order 5 bits represented by the higher order bits signal Sf. Therefore, if the bit pattern of the higher order 5 bits of the 6 bits image data dose not change, the selector 62 selects the same inputting portions irrespective of weather the least significant bit of 6 bits is “0” or “1”.

The outputting device 6 is provided with a switch 63 for switching whether the selector 62 should be connected to the video line 5. The closing or opening of the switch 63 is controlled by the least significant bit signal Slsb representing the least significant bit LSB of the 6 bit image data. If the least significant bit is “1”, the switch 63 is in a closed state over the outputting period Pv. On the other hand, if the least significant bit is “0”, the switch 63 is in a closed state over the odd gray scale period Po of the outputting period Pv, but is in a open state over the even gray scale period Pe.

The outputting device 6 is constructed as described above.

The operation of the outputting device 6 is described in detail. In the description of this operation, the operations of the outputting device 6 in two cases (1) and (2) are taken up: one case (1) in which the image corresponding to the image data “000010” is displayed on the display portion 2 and the other case (2) in which the image corresponding to the image data “000011” is displayed on the display portion 2.

(1) The case in which the image corresponding to the image data “000010” is displayed on the display portion 2

In this case, the image data “000010” is inputted to the outputting device 6. The higher order bits signal Sf representing the higher order 5 bits “00001” of the inputted image data “000010” is inputted to the selector 62 and the least significant bit signal Slsb representing the least significant bit “0” is inputted to the switch 63.

Since the signal Sf inputted to the selector 62 is “00001”, the selector 62 selects the inputting portion In2, which corresponds to the higher order 5 bits “00001”, of 32 inputting portions In1 to In32. Therefore, the selector 62 outputs the gray scale voltage group G2 inputted to the selected inputting portion In2 to the switch 63. Since the gray scale voltage group G2 is the gray scale voltage V3 during the odd gray scale period Po as shown in FIG. 3, the selector 62 outputs the gray scale voltage V3 to the switch 63 during the odd gray scale period Po. On the other hand, the gray scale voltage group G2 changes from the gray scale voltages V3 to V4 by the transition from the odd gray scale period Po to the even gray scale period Pe, so that the selector 62 outputs the gray scale voltage V4 to the switch 63.

Since the signal Slsb inputted to the switch 63 is “0”, the switch 63 is in the closed state during the odd gray scale period Po of the outputting period Pv but is in the open state during the even gray scale period Pe. As a result, the gray scale voltage V3 outputted from the selector 62 during the odd gray scale period Po is supplied to the video line 5, but the gray scale voltage V4 outputted from the selector 62 during the even gray scale period Pe is not supplied to the video line 5 since the switch 63 is opened. Therefore, if the image data is “000010”, the selector 62 outputs the both gray scale voltages V3 and V4, but only gray scale voltage V3 is supplied to the video line 5. The gray scale voltage V3 supplied to the video line 5 is supplied to the source bus Bs via the source driver 4 during the selection period Ps. As described with reference to FIG. 3, the gray scale voltage V3 is outputted from the outputting means 600 during the odd gray scale period Po of the outputting period Pv corresponding to the selection period Ps. Therefore, the gray scale voltage V3 is supplied to the source bus Bs during the selection period Ps for the source bus Bs. The gray scale voltage V3 supplied to the source bus Bs is supplied to the pixel of the display portion 2 selected by the gate bus Bg. In this way, the image corresponding to the image data “000010” can be displayed on the display portion 2

(2) The case in which the image corresponding to the image data “000011” is displayed on the display portion 2

In this case, the image data “000011” is inputted to the outputting device 6. The higher order bits signal Sf representing the higher order 5 bits “00001” of the inputted image data “000011” is inputted to the selector 62 and the least significant bit signal Slsb representing the least significant bit “1” is inputted to the switch 63.

Since the bit pattern ‘00001’ of the higher order bits signal Sf is the same bit pattern as the higher order bits signal Sf of the first-mentioned image data “000010”, the selector 62 selects the inputting In2. Therefore, the selector 62 outputs the gray scale voltage V3 during the odd gray scale period Po and outputs the gray scale voltage V4 during the even gray scale period Pe.

As described above, if the image data “000011” is supplied to the outputting device 6, the selector 62 outputs the gray scale voltages V3 and V4 just as in the case of supplying with the image data “000010”. However, if the image data “000011” is inputted to the outputting device 6, the signal Slsb inputted to the switch 63 is “1”, so that the switch 63 is in the closed state during not only the odd gray scale period Po but also the even gray scale period Pe. Therefore, the gray scale voltage V4 is also supplied to the video line 5 after the gray scale voltage V3 is supplied to the video line 5. The gray scale voltages V3 and V4 supplied to the video line 5 is supplied to the source bus Bs via the source driver 4 during the selection period Ps. As described with reference to FIG. 3, the gray scale voltages V3 and V4 are outputted from the outputting means 600 during the outputting period Pv corresponding to the selection period Ps. Therefore, the both gray scale voltages V3 and V4 are supplied to the source bus Bs during the selection period Ps for the source bus Bs. The gray scale voltages V3 and V4 supplied to the source bus Bs is supplied to the pixel of the display portion 2 selected by the gate bus Bg. The pixel is first supplied with V3 of the gray scale voltages V3 and V4 and then supplied with V4. In this way, the image corresponding to the image data “000011” can be displayed on the display portion 2

The above description is given to the cases in which the images corresponding to the image data “000010” and “000011” are displayed on the display portion 2 respectively, but the similar description is given to image data having the other bit pattern.

As described above, the outputting device 6 controls the closing and opening of the switch 63 on the basis of whether the least significant bit of the inputted image data is ‘1’ or ‘0’, so that the gray scale voltage corresponding to the image data can be outputted.

In the outputting device 6, two gray scale voltages are outputted from each of the outputting portions Out1 to Out32 of the outputting means 600, so that 64 gray scale voltages in total are outputted. That is to say, the number of the outputting portions required in the outputting means 600 is only half of the number of the gray scale voltages to be outputted. Therefore, it is not necessary to provide the outputting means 600 with 64 outputting portions Out corresponding to 64 gray scale voltages, so that the miniaturization of the outputting means 600 is achieved.

The total number of the inputting portions In1 to In32 required in the selector 62 is 32 which is the same number as the total number of the outputting portions Out1 to Out32 of the outputting means 600. Therefore, the number of the switches required in the selector 62 for the purpose of the switching of the inputting portions In1 to In32 is also only 32. As a result of this, it is not necessary to provide the selector 62 with such 64 switches corresponding to 64 gray scale voltages, so that the miniaturization of the selector 62 is achieved.

It is noted that, in this embodiment, the length of the odd gray scale period Po of each outputting periods Pv is preferably as long as possible. For the purpose of explaining this reason, the case is discussed in which a pixel Pix1 is supplied with a gray scale voltage Vα during a certain selection period for a source bus BS and subsequently a pixel Pix2 adjacent to the pixel Pix1 is supplied with a gray scale voltage Vβ during the next selection period for the same source bus Bs. In this case, the voltage on the source bus Bs reaches the gray scale voltage Vα during the certain selection period and then changes from the gray scale voltage Vα to Vβ during the next selection period. Therefore, the display portion 2 displays the image corresponding to the gray scale voltage Vα during the certain selection period and displays the image corresponding to the gray scale voltage Vβ during the next selection period. In order for the display portion 2 to display the image of high quality, the voltage on the source bus Bs which has reached the gray scale voltage Vα during the certain selection period must change from the gray scale voltage Vα to the gray scale voltage Vβ by the time when the next selection period is ended. If the difference between the gray scale voltages Vα and Vβ is small (for example, the gray scale voltages V1 and V2), the amount of change in the voltage on the source bus during the next selection period is small, so that the voltage on the source bus Bs changes instantaneously from the gray scale voltage Vα to VP. However, if the difference between the gray scale voltages Vα and Vβ is large (for example, the gray scale voltages V1 and V63), the amount of change in the voltage on the source bus during the next selection period is large, so that, for example, if the voltage Vβ is outputted during the odd gray scale period Po and the odd gray scale period Po is too short, the supply of the gray scale voltage Vβ to the source bus Bs is ended before the voltage on the source bus Bs changes from the gray scale voltage Vα to Vβ. In this case, the quality of image displayed on the display portion 2 is degraded.

For the purpose of preventing from such degradation of the image, it is preferable that the odd gray scale period Po is as long as possible. The longer the odd gray scale period Po is, the longer the period for supplying the source bus Bs with the gray scale voltage Vβ during the next selection period can become, so that the voltage on the source bus Bs can reach the gray scale voltage Vβ even if the difference between the gray scale voltages Vα and Vβ is large.

If the odd gray scale period Po is longer, the even gray scale voltage period Pe must be shorter accordingly. Therefore, as shown in FIG. 3, the period during which the source bus Bs is supplied with the gray scale voltage V2x of the even gray scale voltage Pe becomes shorter than the period during which the source bus Bs is supplied with the gray scale voltage V2x−1 of the odd gray scale period Po. However, the source bus Bs has been supplied with the gray scale voltage V2x−1 of the odd gray scale period Po until the time come when the source bus Bs is supplied with the gray scale voltage V2x of the even gray scale period Pe, and the difference between gray scale voltages V2x−1 and V2x is very slight. Therefore, in spite of the shorter even gray scale period Pe, the voltage on the source bus Bs reaches instantaneously from the gray scale voltage V2x−1 to V2x. As a result, there is no problem if the even gray scale period Pe is shorter than the odd gray scale period Po.

In this embodiment, the outputting device 6 which outputs 64-level gray scale voltages V1 to V64 is taken up. However, it is noted that the present invention is not limited to the outputting device which outputs 64-level gray scale voltages V1 to V64 and can be applied to the outputting device which outputs, for example, 512-level gray scale voltages V1 to V512.

### A Second Embodiment

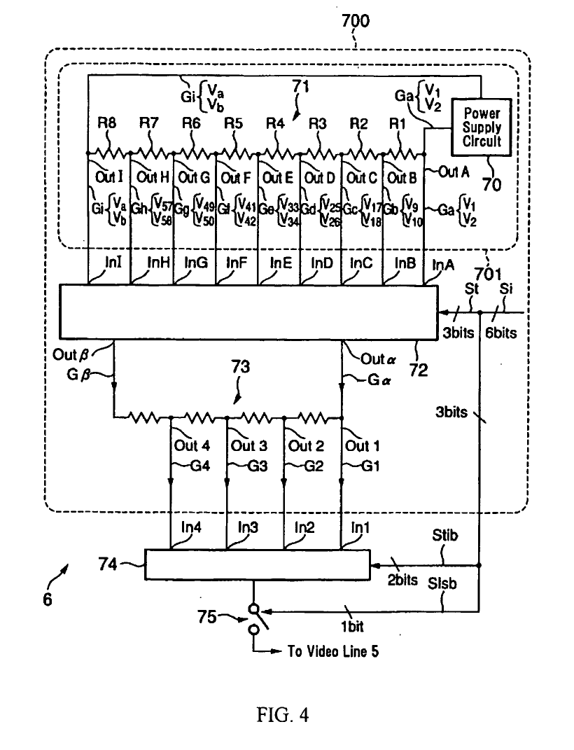

FIG. 4 is a schematic diagram of the gray scale voltage outputting device 6 of a second embodiment according to the present invention.

The outputting device 6 shown in FIG. 4 is described with emphasis on the difference between the outputting devices shown in FIGS. 2 and 4.

The outputting device 6 shown in FIG. 4 is provided with a gray scale voltage group outputting means 700 which can generate 64-level gray scale voltages V1 to V64. It is noted that the outputting means 600 shown in FIG. 2 comprises 32 gray scale voltage group outputting portions Out1 to Out32, but the outputting means 700 shown in FIG. 4 comprises 4 gray scale voltage group outputting portions Out1 to Out4.

The outputting means 700 shown in FIG. 4 comprises a reference voltage group outputting stage 701. The outputting stage 701 comprises 9 reference voltage group outputting portions OutA to OutI. Furthermore, the outputting stage 701 is provided with a power supply circuit 70 and a resistor chain 71 comprising resistors R1 to R8 in series. The voltages generated by using the power circuit 70 and the resistor chain 71 are outputted from the outputting portions OutA to OutI of the outputting stage 701.

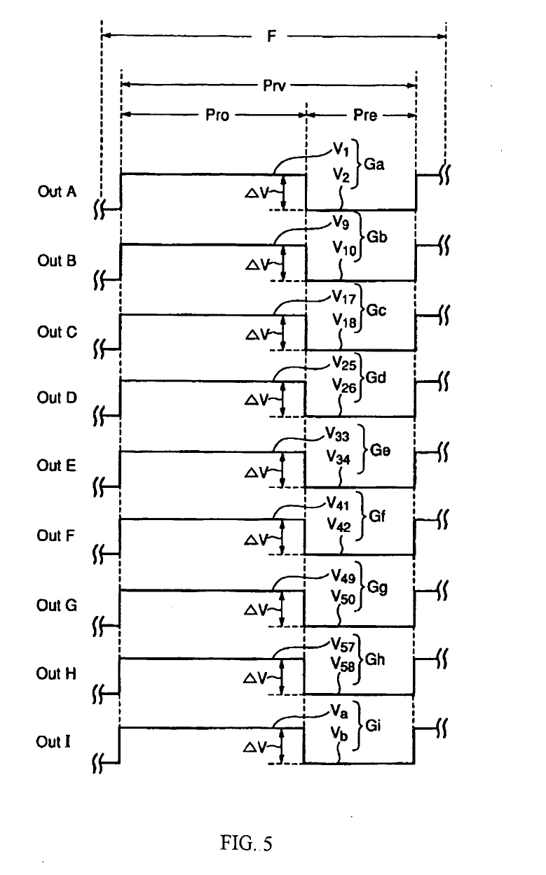

FIG. 5 is a graph showing the reference voltage groups Ga to Gi outputted from the outputting portions OutA to OutI of the outputting stage 701 shown in FIG. 4. FIG. 5 schematically shows, in a frame period F, voltage wave forms of the voltage groups which are outputted from the outputting portions OutA to OutI during a reference voltage group outputting period Prv corresponding to one selection period Ps for the source bus. In FIG. 5, it is noted that, for the sake of convenience, the voltage values of the voltage groups are shown as absolute values of the differences from the value of voltage supplied to a common electrode (not shown) of the display portion 2 shown in FIG. 1.

The power supply circuit 70 (see FIG. 4) generates the reference voltage group Ga having the gray scale voltages V1 and V2 and the reference voltage group Gi having non gray scale voltages Va and Vb which are not used as gray scale voltages. It is noted that the non gray scale voltages Va and Vb are not used as gray scale voltages but are used for generating, gray scale voltages which are not outputted from the 8 outputting portions OutA to OutH of the outputting stage 701, from the succeeding resistor chain 73.

The reference voltage group Ga is outputted from the outputting portions OutA of the outputting stage 701 during the outputting period Prv and the reference voltage group Gi is outputted from the outputting portions Out1 of the outputting stage 701 during the outputting period Prv. The outputting period Prv is divided into a reference odd gray scale period Pro and a reference even gray scale period Pre. The gray scale voltage V1 of the reference voltage group Ga is outputted during the reference odd gray scale period Pro and the gray scale voltage V2 is outputted during the reference even gray scale period Pre. Furthermore, the non gray scale voltage Vα of the reference voltage group Gi is outputted during the reference odd gray scale period Pro and the non gray scale voltage Vb is outputted during the reference even gray scale period Pre. The gray scale voltage V2 is defined so as to be smaller than the gray scale voltage V1 by ΔV and the non gray scale voltage Vb is also defined so as to be smaller than the non gray scale voltage Vα by ΔV.

The generated reference voltage groups Ga and Gi from the power supply circuit 70 are outputted from the outputting portions OutA and OutI of the outputting stage 701 and are applied across the resistor chain 71. By applying the reference voltage groups Ga and Gi across the resistor chain 71, the resistor chain 71 generates the reference voltage groups Gb to Gh. The generated reference voltage groups Gb to Gh are outputted from the outputting portions OutB to OutH of the outputting stage 701. Therefore, the outputting stage 701 can output the reference voltage groups Ga to Gi from the outputting portions OutA to OutI. In the reference odd gray scale period Pro, the gray scale voltage V1 and the non gray scale voltage Vα are applied across the resistor chain 71, so that the resistor chain 71 generates gray scale voltages V9, V17, V25, V33, V41, V49, and V57 between the gray scale voltage V1 and the non gray scale voltage Va. Therefore, 8 gray scale voltages V1, V9, V17, V25, V33, V41, V49, and V57 of odd levels are outputted from 8 outputting portions OutA to OutH of the outputting stage 701 and the non gray scale voltage Vb is outputted from the outputting portion OutI.

On the other hand, in the reference even gray scale period Pre, the gray scale voltage V2 and the non gray scale voltage Vb are applied across the resistor chain 71, so that the resistor chain 71 generates gray scale voltages V10, V18, V26, V34, V42, V50 and V58 between the gray scale voltage V2 and the non gray scale voltage Vb. Therefore, 8-gray scale voltages V2, V10, V18, V26, V34, V42, V50, and V58 of even levels are outputted from 8 outputting portions OutA to OutH of the outputting stage 701 and the non gray scale voltage Vb is outputted from the outputting portion OutI.

As described above, the gray scale voltage V2 outputted from the outputting portions OutA during the reference even gray scale period Pre is defined so as to be smaller than the gray scale voltage V1 outputted during the reference odd gray scale period Pro by ΔV. The non gray scale voltage Vb outputted from the outputting portions Out1 during the reference even gray scale period Pre is also defined so as to be smaller than the non gray scale voltage Va outputted during the reference odd gray scale period Pro by ΔV. Therefore, gray scale voltages outputted from the other outputting portions OutB to OutH during the reference even gray scale period Pre are smaller than the gray scale voltages outputted during the reference odd gray scale period Pro by ΔV, respectively.

The outputting stage 701 outputs 8 gray scale voltages V8n−7 (n is integer of 1 to 8 inclusive) of odd levels and the non gray scale voltage Vα during the reference odd gray scale period Pro and outputs 8 gray scale voltages V8n−6 (n is integer of 1 to 8 inclusive) of even levels and the non gray scale voltage Vb during the reference even gray scale period Pre. The non gray scale voltages Va and Vb are not used as gray scale voltages, so that the outputting stage 701 outputs 16 gray scale voltages V8n−7 and V8n−6 (n is integer of 1 to 8 inclusive) of 64 gray scale voltages V1 to V64. The outputting means 700 shown in FIG. 4 is constructed as described below for the purpose of generating the remaining 48 gray scale voltages.

The outputting means 700 comprises a selector 72. The selector 72 is provided with 9 reference voltage group inputting portions InA to InI corresponding to 9 outputting portions OutA to Out1 of the outputting stage 701. The outputted voltage group from the outputting portions OutA to OutI of the outputting stage 701 are inputted to the corresponding inputting portions InA to InI of the selector 72. The selector 72 receives a higher order bits signal St which represents higher order 3 bits THB (Three Highmost Bits) containing a most significant bit MSB of 6 bits image data. The selector 72 selects a pair of two adjacent inputting portions, which corresponds to a bit pattern of the higher order 3 bits represented by the higher order bits signal St, of the inputting portions InA to InI and then outputs the voltage groups inputted to the selected pair of two inputting portions from the outputting portions Outα and Outβ as the voltage groups Gα and Gβ. The selector 72 comprises 9 inputting portions InA to InI, so that the number of pairs of two adjacent inputting portions is 8 (i.e. (InA, InB), (InB, InC), . . . , (InG, InH), and (InH, InI)). Since the higher order bits signal St can take 8 (=23) bit patterns, the selector 72 is allowed to select each of 8 pairs of two adjacent inputting portions in accordance with the bit pattern of the higher order 3 bits represented by the higher order bits signal St. Therefore, if the bit pattern of the higher order 3 bits of the 6 bits image data dose not change, the selector 72 selects the same pair of inputting portions. For example, if the bit pattern of the higher order bits signal St is ‘000’, the selector 72 selects the inputting portions InA and InB, so that the selector 72 outputs the reference voltage group Ga as the voltage group Gα and outputs the reference voltage group Gb as the voltage group Gβ. If the bit pattern of the higher order bits signal St is ‘111’, the selector 72 selects the inputting portions InH and InI, so that the selector 72 outputs the reference voltage group Gh as the voltage group Ga and outputs the reference voltage group Gi as the voltage group Gβ.

The outputting means 700 comprises a resistor chain 73. The outputted voltage groups Gα and Gβ from the selector 72 are applied across the resistor chain 73, so that gray scale voltages G2, G3 and G4 are generated by the resistor chain 73. The gray scale voltage groups G2, G3, and G4 are outputted from the outputting portions Out2, Out3, and Out4, respectively. Ga of the outputted voltage groups Gα and Gβ from the selector 72 is outputted from the outputting portion Out1 as the gray scale voltage group G1. Therefore, the outputting means 700 outputs the gray scale voltage groups G1 to G4 from the 4 outputting portions Out1 to Out4. The voltage values of the gray scale voltage groups G1 to G4 changes depending on which pair of two inputting portions is selected by the selector 72.

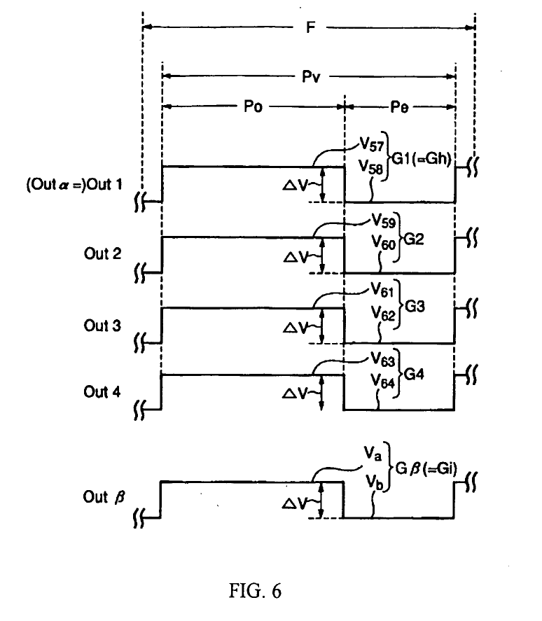

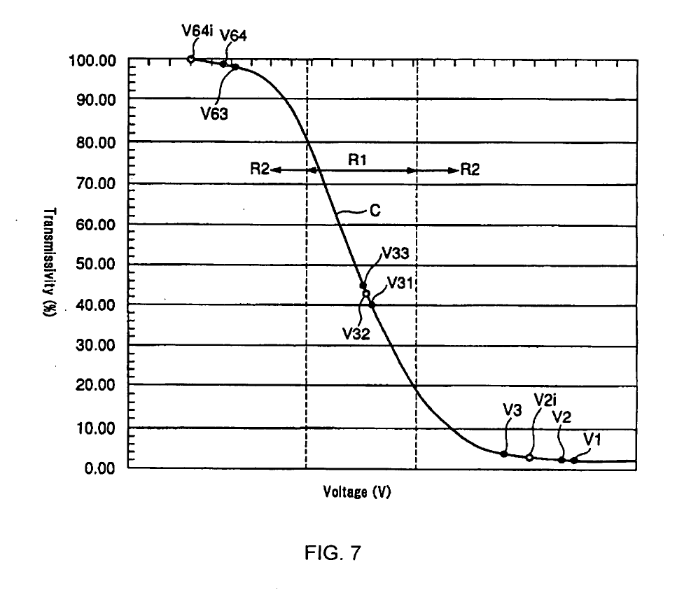

FIG. 6 is a graph showing one example of the gray scale voltage groups outputted from 4 outputting portions Out1 to Out4 of the outputting means 700, respectively. FIG. 6 schematically shows, in a frame period F, voltage wave forms of the gray scale voltage groups G1 to G4 which are outputted from the outputting portions Out1 to Out4 during a gray scale voltage group outputting period Pv when the selector 72 selects two inputting portions InH and InI. In FIG. 6, it is noted that, for the sake of convenience, the voltage values of the gray scale voltage groups G1 to G4 are shown as absolute values of the differences from the value of voltage supplied to a common electrode (not shown) of the display portion 2.

If the selector 72 selects two inputting portions InH and InI, the selector 72 outputs the reference voltage group Gh inputted to the inputting portion InH from the outputting portions Outα as the voltage group Gα and outputs the reference voltage group Gi inputted to the inputting portion InI from the outputting portions Outβ as the voltage group Gβ. The voltage group Gα(=Gh) is outputted from the outputting portions Out1 of the outputting means 700 during the outputting period Pv as the gray scale voltage group G1. The outputting period Pv is divided into an odd gray scale period Po and an even gray scale period Pe. The gray scale voltage V57 of the gray scale voltage group G1 (=Gh) is outputted during the odd gray scale period Po and the gray scale voltage V58 is outputted during the even gray scale period Pe.

The outputted voltage groups Gα(=Gh) and Gβ(=Gi) from the selector 72 are applied across the resistor chain 73. By applying the voltage groups Gα(=Gh) and Gβ(=Gi) across the resistor chain 73, the resistor chain 73 generates the gray scale voltage groups G2 to G4. The generated gray scale voltage groups G2 to G4 are outputted from the outputting portions Out2 to Out4 of the outputting means 700. Therefore, the outputting means 700 can output the gray scale voltage groups G1 to G4 from 4 outputting portions Out1 to Out4 during outputting period Pv. In the odd gray scale period Po, the gray scale voltage V57 and the non gray scale voltage Vα are applied across the resistor chain 73, so that the resistor chain 73 generates gray scale voltages V59, V61 and V63 between the gray scale voltage V57 and the non gray scale voltage Vα (It is noted that a value of the non gray scale voltage Vα is set in such a way that the gray scale voltages V59, V61, and V63 are outputted from the outputting means 700). Therefore, 4 gray scale voltages V57, V59, V61, and V63 of odd levels are outputted from the outputting portions Out1 to Out4 of the outputting means 700 during the odd gray scale period Po.

On the other hand, in the even gray scale period Pe, the gray scale voltage V58 and the non gray scale voltage Vb are applied across the resistor chain 73, so that the resistor chain 73 generates gray scale voltages V60, V62 and V64 between the gray scale voltage V58 and the non gray scale voltage Vb (It is noted that a value of the non gray scale voltage Vb is set in such a way that the gray scale voltages V60, V62, and V64 are outputted from the outputting means 700). Therefore, 4 gray scale voltages V58, V60, V62, and V64 of even levels are outputted from the outputting portions Out1 to Out4 of the outputting means 700.

The gray scale voltage V58 outputted from the outputting portions Outα of the selector 72 is defined so as to be smaller than the gray scale voltage V57 by ΔV (see FIG. 5) and the non gray scale voltage Vb outputted from the outputting portions Outβ is also defined so as to be smaller than the non gray scale voltage Vα by ΔV. Therefore, the gray scale voltages V58, V60, V62, and V64 outputted from 4 outputting portions Out1 to Out4 of the outputting means 700 during the even gray scale period Pe are smaller than the gray scale voltages V57, V59, V61, and V63 outputted during the odd gray scale period Po by ΔV, respectively.

As described above, the outputting means 700 can output 8 gray scale voltages V57 to V64.

In the example described above, the case in which the selector 72 selects a pair of inputting portions InH and InI is described. The case in which the selector 72 selects different pair of inputting portions is described similarly. For example, if the selector 72 selects a pair of inputting portions InA and InB, the selector 72 outputs the reference voltage group Ga (gray scale voltages V1 and V2) from the outputting portions Outα and outputs the reference voltage group Gb (gray scale voltages V9 and V10) from the outputting portions Outβ. In this case, the outputted reference voltage group Ga (gray scale voltages V1 and V2) from the outputting portions Outα is outputted from the outputting portion Out1 of the outputting means 700, but the outputted reference voltage group Gb (gray scale voltages V9 and V10) from the outputting portions Outβ is not outputted from 4 outputting portions Out1 to Out4 of the outputting means 700. However, by applying the reference voltage group Ga (gray scale voltages V1 and V2) and the reference voltage group Gb (gray scale voltages V9 and V10) across the resistor chain 73, 8 gray scale voltages V1 to V8 can be outputted from 4 outputting portions Out1 to Out4 of the outputting means 700. If the selector 72 selects a pair of inputting portions InB and InC, the selector 72 outputs the reference voltage group Gb (gray scale voltages V9 and V10) from the outputting portions Outα and outputs the reference voltage group Gc (gray scale voltages V17 and V18) from the outputting portions Outβ. In this case, the outputted reference voltage group Gc (gray scale voltages V17 and V18) from the outputting portions Outβ is not outputted from 4 outputting portions Out1 to Out4 of the outputting means 700. However, by applying the reference voltage group Gb (gray scale voltages V9 and V10) and the reference voltage group Gc (gray scale voltages V17 and V18) across the resistor chain 73, 8 gray scale voltages V9 to V16 can be outputted from 4 outputting portions Out1 to Out4 of the outputting means 700. Therefore, if the selector 72 changes a pair of two inputting portions to be selected, it is possible to output all of the gray scale voltages V1 to V64.

The outputted gray scale voltages from the outputting means 700 is inputted to a selector 74. The selector 74 is provided with 4 gray scale voltage group inputting portions In1 to In4 corresponding to 4 outputting portions Out1 to Out4 of the outputting means 700. The outputted gray scale voltage groups G1 to G4 from 4 outputting portions Out1 to Out4 of the outputting means 700 are inputted to the corresponding inputting portions In1 to In4 of the selector 74. The selector 74 receives an intermediate order bits signal Stib representing an intermediate order 2 bits TIB (Two Intermediate Bits) of 6 bits image data. The selector 74 selects one of 4 inputting portions In1 to In4 corresponding to a bit pattern of the intermediate order 2 bits represented by the intermediate order bits signal Stib and then outputs the gray scale voltage group inputted to the selected inputting portion. Since the intermediate order bits signal Stib can take 4 (=22) bit patterns, the selector 74 is allowed to select each of 4 inputting portions In1 to In4 in accordance with the bit pattern of the intermediate order 2 bits represented by the intermediate order bits signal Stib. Therefore, if the bit pattern of the intermediate order 2 bits of the 6 bits image data dose not change, the selector 74 selects the same inputting portions.

The outputting device 6 is provided with a switch 75 for switching whether the selector 74 should be connected to the video line 5. The closing or opening of the switch 75 is controlled by the least significant bit signal Slsb representing the least significant bit LSB of the 6 bit image data. If the least significant bit is “1”, the switch 75 is in a closed state over the outputting period Pv. On the other hand, if the least significant bit is “0”, the switch 75 is in a closed state over the odd gray scale period Po of the outputting period Pv, but is in an open state over the even gray scale period Pe.

The outputting device 6 is constructed as described above.

The operation of the outputting device 6 is described in detail. In the description of this operation, the operations of the outputting device 6 in two cases (1) and (2) are taken up: one case (1) in which the image corresponding to the image data “111110” is displayed on the display portion 2 and the other case (2) in which the image corresponding to the image data “111111” is displayed on the display portion 2.

(1) The case in which the image corresponding to the image data “111110” is displayed on the display portion 2

In this case, the image data “111110” is inputted to the outputting device 6. The higher order bits signal St representing the higher order 3 bits “111” of the inputted image data “111110” is inputted to the selector 72.

Since the signal St inputted to the selector 72 is “111”, the selector 72 selects a pair of two inputting portions InH and InI, which corresponds to the higher order 3 bits “111”, of inputting portions InA to InI. Therefore, the selector 72 outputs the reference voltage group Gh inputted to the inputting portion InH from the outputting portion Outα and outputs the reference voltage group Gi inputted to the inputting portion InI from the outputting portion Outβ. Since the reference voltage group Gh is the gray scale voltage V57 during the reference odd gray scale period Pro and is the gray scale voltage V58 during the reference even gray scale period Pre as shown in FIG. 5, the selector 72 outputs the gray scale voltage V57 during the reference odd gray scale period Pro and outputs the gray scale voltage V58 during the reference even gray scale period Pre. Since the reference voltage group Gi is the non gray scale voltage Vα during the reference odd gray scale period Pro and is the non gray scale voltage Vb during the reference even gray scale period Pre as shown in FIG. 5, the selector 72 outputs the non gray scale voltage Vα during the reference odd gray scale period Pro and outputs the non gray scale voltage Vb during the reference even gray scale period Pre.

The selector 72 outputs the reference voltage group Gh (gray scale voltages V57 and V58) from the outputting portion Outα and outputs the reference voltage group Gi (non gray scale voltages Va and Vb) from the outputting portion Outβ. Therefore, as described with reference to FIG. 6, 4 outputting portions Out1 and Out4 of the outputting means 700 output the gray scale voltage group G1 (gray scale voltages V57 and V58), the gray scale voltage group G2 (gray scale voltages V59 and V60), the gray scale voltage group G3 (gray scale voltages V61 and V62), and the gray scale voltage group G4 (gray scale voltages V63 and V64).

The outputted gray scale voltage groups G1 to G4 from the outputting portions Out1 to Out4 of the outputting means 700 are inputted to the selector 74. Since the bit pattern of the image data supplied to the outputting device 6 is “111110”, the intermediate order bits signal Stib inputted to the selector 74 is “11”. If the intermediate order bits signal Stib is “11”, the selector 74 selects the inputting portion In4, which corresponds to the bit pattern “11”, of 4 inputting portions In1 to In4. Therefore, the selector 74 outputs the gray scale voltage group G4 inputted to the selected inputting portion In4 to the switch 75. Since the gray scale voltage group G4 is the gray scale voltages V63 and V64 as shown in FIG. 6, the selector 74 outputs the gray scale voltage V63 to the switch 75 during the odd gray scale period Po and outputs the gray scale voltage V64 to the switch 75 during the even gray scale period Pe.

Since the bit pattern of the image data supplied to the outputting device 6 is “111110”, the lowest order bit signal Slsb inputted to the switch 75 is “0”. Therefore, the switch 75 is in the closed state during the odd gray scale period Po, but is in the open state during the even gray scale period Pe. As a result, the outputted gray scale voltage V63 from the selector 74 during the odd gray scale period Po is supplied to the video line 5, but the outputted gray scale voltage V64 from the selector 74 during the even gray scale period Pe is not supplied to the video line 5 since the switch 75 is opened. Therefore, if the image data is “111110”, the selector 74 outputs the both gray scale voltages V63 and V64, but only gray scale voltage V63 is supplied to the video line 5. The gray scale voltage V63 supplied to the video line 5 is supplied to the source bus Bs via the source driver 4 during the selection period Ps. As described with reference to FIG. 6, the gray scale voltage V63 is outputted from the outputting means 700 during the odd gray scale period Po of the outputting period Pv corresponding to the selection period Ps. Therefore, the gray scale voltage V63 is supplied to the source bus Bs during the selection period Ps for the source bus Bs. The gray scale voltage V63 supplied to the source bus Bs is supplied to the pixel of the display portion 2 selected by the gate bus Bg. Therefore, the image corresponding to the image data “111110” can be displayed on the display portion 2

(2) The case in which the image corresponding to the image data “111111” is displayed on the display portion 2

In this case, the image data “111111” is inputted to the outputting device 6. The higher order bits signal St of image data “111111” has the same bit pattern “111” as the higher order bits signal St of the first-mentioned image data “111110”. Therefore, as described with reference to FIG. 6, 4 outputting portions Out1 and Out4 of the outputting means 700 output the gray scale voltage group G1 (gray scale voltages V57 and V58), the gray scale voltage group G2 (gray scale voltages V59 and V60), the gray scale voltage group G3 (gray scale voltages V61 and V62), and the gray scale voltage group G4 (gray scale voltages V63 and V64).

The outputted gray scale voltage groups G1 to G4 from the outputting portions Out1 to Out4 of the outputting means 700 are inputted to the selector 74. The intermediate order bits signal Stib supplied to the selector 74 has the same bit pattern “11” as the intermediate order bits signal Stib of the first-mentioned image data “111110”. Therefore, the selector 74 outputs the gray scale voltage V63 to the switch 75 during the odd gray scale period Po and outputs the gray scale voltage V64 to the switch 75 during the even gray scale period Pe.

It is noted that the lowest order bit signal Slsb supplied to the switch 75 is “1” since the bit pattern of the image data supplied to the outputting device 6 is “111111”. In this case, the switch 75 is in the closed state during not only the odd gray scale period Po but also the even gray scale period Pe. Therefore, after the gray scale voltage V63 is supplied to the video line 5, the gray scale voltage V64 is also supplied to the video line 5. The gray scale voltages V63 and 64 supplied to the video line 5 are supplied to the source bus Bs via the source driver 4 during the selection period Ps. As described with reference to FIG. 6, the gray scale voltages V63 and 64 are outputted from the outputting means 700 during the outputting period Pv corresponding to the selection period Ps. Therefore, both gray scale voltages V63 and V64 are supplied to the source bus Bs during the selection period Ps for the source bus Bs. The gray scale voltages V63 and 64 supplied to the source bus Bs are supplied to the pixel of the display portion 2 selected by the gate bus Bg. This pixel is first supplied with V63 of the gray scale voltages V63 and V64 and then is supplied with V64. Therefore, the image corresponding to the image data “111111” can be displayed on the display portion 2.

The above description is given to the cases in which the images corresponding to the image data “111110” and “111111” are displayed on the display portion 2 respectively, but the similar description is given to an image data having the other bit pattern.

In such outputting device 6, two gray scale voltages (or two non gray scale voltages) are outputted from each of 9 outputting portions OutA to OutI of the outputting stage 701, so that 18 reference voltages (the gray scale voltages and the non gray scale voltages) in total are generated. That is to say, the number of the outputting portions required in the outputting stage 701 is only half of the number of the gray scale voltages to be outputted. Therefore, the miniaturization of the outputting stage 701 is achieved.

Since the number of the outputting portions required in the outputting stage 701 can be reduced to half, the miniaturizations of the selector 72, the resistor chain 73 and the selector 74 are achieved accordingly. Especially, the substantial miniaturizations of the selectors 72 and 74 are achieved since the number of the switches required in the selector 72 for the purpose of selecting the outputted voltages from the outputting stage 701 can be reduced to half and the number of the switches required in the selector 74 for the purpose of selecting the outputted voltages from the outputting means 700 can be reduced to half In this second embodiment, the reference voltage group Gα outputted from the outputting portion Outα of the selector 72 is used as the gray scale voltage group G1. If the reference voltage group also serves as the gray scale voltage group, the outputting means 700 is made smaller.

The above description is given to the operations of two outputting devices 6 (see FIGS. 2 and 4). Next, the quality of image displayed on the display portion 2 by the liquid crystal display device 1 shown in FIG. 1 is discussed.

If each of 64 gray scale voltages V1 to V64 is supplied with the display portion 2, the transmissivity T of the display portion 2 becomes the transmissivity T corresponding to each gray scale voltage. The value of the transmissivity T affects the quality of image displayed on the display portion 2. In order for the display portion 2 to display the image having a good quality, it is important that, when the display portion 2 is supplied with each of 64 gray scale voltages V1 to V64, the transmissivity of the display portion 2 becomes as close as possible to a transmissivity for displaying the image having the best quality (hereinafter, referred to as “ideal transmissivity”). The ideal transmissivity differs according to 64 gray scale voltages V1 to V64. Therefore, in order for the display portion 2 to display the image having a good quality, each of the 64 gray scale voltages V1 to V64 is required to be as close as possible to a gray scale voltage for obtaining the ideal transmissivity (hereinafter, referred to as “ideal gray scale voltage”). In the case of, for example, the outputting device 6 shown in FIG. 2, the values of the gray scale voltages V1 to V64 depend on the values of resistors R1 to R31 of the resistor chain 61, so that it is possible to bring 64 gray scale voltages V1 to V64 close to the ideal gray scale voltages by adjusting the resistor values R1 to R31 of the resistor chain 61. However, in the case of the outputting device 6 shown in FIG. 3, the gray scale voltages V2n−1 of odd levels are not generated at the same time as the gray scale voltages V2n of even levels and the gray scale voltages V2n−1 are outputted from the same outputting portions Out as the corresponding gray scale voltages V2n. Therefore, if the resistors R1 to R31 of the resistor 61 are defined in such a way that the gray scale voltages V2n−1 of odd levels accord with its own ideal gray scale voltages, the gray scale voltages V2n of even levels deviate from the ideal gray scale voltages. The reason that this deviation arises is described with reference to FIG. 7.

FIG. 7 shows a V-T curve C representing a V-T characteristic of the display portion 2.

If the values of resistors R1 to R31 of the resistor chain 61 are defined in such a way that 32 gray scale voltages V2n−1 of odd levels accord with its own ideal gray scale voltages, the transmissivities T at the time when the display portions 2 are supplied with gray scale voltages V2n−1 accord with its own ideal transmissivities, respectively (In FIG. 7, the gray scale voltages V1, V3, V31, V33 and V63 are illustrated as the representatives of the gray scale voltages V2n−1 of odd levels). The outputting means 600 outputs the gray scale voltages V2n−1 of odd levels and then changes the gray scale voltages V2n−1 by ΔV to output the gray scale voltages V2n of even levels (see FIG. 3). In FIG. 7, the gray scale voltages V2, V32, and V64 are illustrated as the representatives of the gray scale voltages V2n of even levels. If the value of ΔV is selected in such a way that the gray scale voltage V32 accords with its own ideal gray scale voltage, the gray scale voltages V2n accord with its own ideal gray scale voltages in a region R1 in which the V-T curve C exhibits linearity. However, the deviations of the gray scale voltages V2n from the ideal gray scale voltages are larger in regions R2 in which the V-T curve C exhibits non-linearity. For example, as shown in FIG. 7, the ideal gray scale voltage V2i of the gray scale voltage V2 is located between the gray scale voltages V1 and V3 near the gray scale voltage V3 to some extent, but the actually outputted gray scale voltages V2 from the outputting means 600 is located near the gray scale voltage V1, so that the gray scale voltage V2 can not be accord with its own ideal gray scale voltage V2i. Furthermore, as shown in FIG. 7, the ideal gray scale voltage V64i of the gray scale voltage V64 is located at the position where the transmissivity T is equal to 100%, but the actually outputted gray scale voltages V64 from the outputting means 600 is located near the gray scale voltage V 63, so that the gray scale voltage V64 can not be accord with its own ideal gray scale voltage V64i.

FIG. 7 shows the case in which the values of resistors R1 to R31 of the resistor chain 61 are defined in such a way that gray scale voltages V2n−1 of odd levels accord with its own ideal gray scale voltages, but the similar description is given to the case in which the values of resistors R1 to R31 of the resistor chain 61 are defined in such a way that gray scale voltages V2n of even levels accord with its own ideal gray scale voltages.

As described above, in the case of the outputting device 6 shown in FIG. 2, it is difficult to bring the gray scale voltages within the non linearity region R2 close to the ideal gray scale voltages. If it is desired that the image displayed on the display portion 2 has higher quality, a gray scale voltage outputting device 6 described below can also be used.

### A Third Embodiment

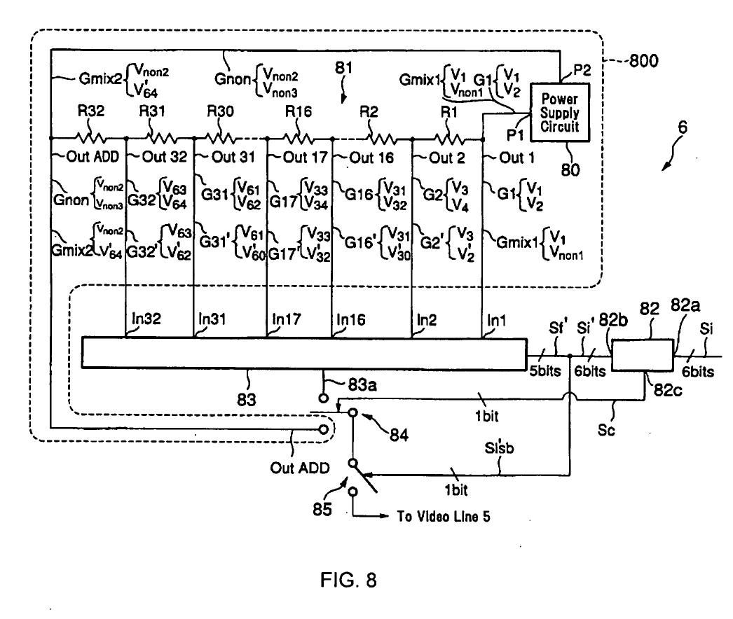

FIG. 8 is a schematic diagram of the gray scale voltage outputting device 6 according to the third embodiment.

This outputting device 6 is preferably used in the image display device for which FRC (Frame Rate Control) scheme for displaying one image using successive 4 frame periods is adopted.

The outputting device 6 is provided with a gray scale voltage group outputting means 800 which can generate 64-level gray scale voltages V1 to V64. The outputting means 800 comprises 32 gray scale voltage group outputting portions Out1 to Out32 and one voltage outputting portion OutADD which is added for displaying the image corresponding to the ideal gray scale voltage V64 (see FIG. 7). Furthermore, the outputting means 800 is provided with a power supply circuit 80 and a resistor chain 81 comprising resistors R1 to R32 in series. The voltages generated by using the power circuit 80 and the resistor chain 81 are outputted from the outputting portions Out1 to Out32 and OutADD of the outputting means 800.

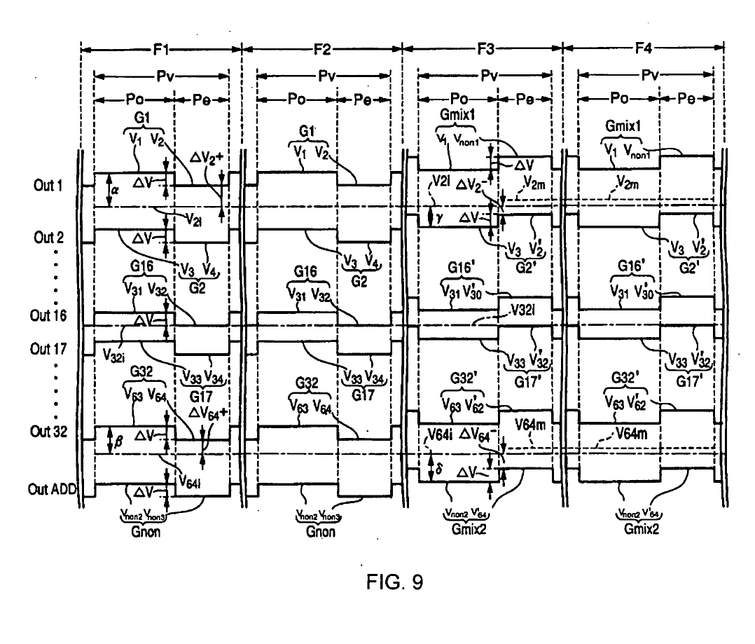

FIG. 9 is a graph showing voltages outputted from the outputting portions Out1 to Out32 and OutADD of the outputting means 800. FIG. 9 schematically shows, in successive 4 frame periods F1 to F4, wave forms of voltages outputted from the outputting portions OutI to Out32 and OutADD during gray scale voltage group outputting periods Pv each of which corresponds to one selection period Ps for the source bus. In FIG. 9, it is noted that, for the sake of convenience, the values of voltages outputted from the outputting portions Out1 to Out32 and OutADD are shown as absolute values of the difference from the value of the voltage supplied to a common electrode (not shown) of the display portion 2.

The power supply circuit 80 (see FIG. 8) generates, from a first outputting portion P1, a gray scale voltage group G1 having the gray scale voltages V1 and V2 and a mixed voltage group Gmix1 having the gray scale voltage V1 and a non gray scale voltage Vnon1. The gray scale voltages V1 and V2 are used as gray scale voltages, but the non gray scale voltage Vnon1 is not used as gray scale voltage.

Both the gray scale voltage group G1 and the mixed voltage group Gmix1 are outputted from the outputting portion Out1 of the outputting means 800. However, the gray scale voltage group G1 is outputted from the outputting portion Out1 during the outputting periods Pv of two frame periods F1 and F2 which are the first half of successive 4 frame periods F1 to F4. The mixed voltage group Gmix1 is outputted from the outputting portion Out1 during the outputting periods Pv of two frame periods F3 and F4 which are the second half of successive 4 frame periods F1 to F4. The outputting period Pv is divided into an odd gray scale period Po and an even gray scale period Pe. The gray scale voltage V1 of the gray scale voltage group G1 is outputted during the odd gray scale period Po and the gray scale voltage V2 is outputted during the even gray scale period Pe. The gray scale voltage V2 is defined so as to be smaller than the gray scale voltage V1 by ΔV. The gray scale voltage V1 of the mixed voltage group Gmix1 is outputted during the odd gray scale period Po and the non gray scale voltage Vnon1 is outputted during the even gray scale period Pe. The non gray scale voltage Vnon1 is defined so as to be larger than the gray scale voltage V1 by ΔV. Therefore, it is noted that, in two frame periods F1 and F2 of the first half, the gray scale voltage V2 during the even gray scale period Pe is smaller than the gray scale voltage V1 during the odd gray scale period Po by ΔV, but in two frame periods F3 and F4 of the second half, the non gray scale voltage Vnon1 during the even gray scale period Pe is larger than the gray scale voltage V1 during the odd gray scale period Po by ΔV.

The power supply circuit 80 (see FIG. 8) generates, from a second outputting portion P2, a non gray scale voltage group Gnon having the non gray scale voltages Vnon2 and Vnon3 and a mixed voltage group Gmix2 having the non gray scale voltage Vnon2 and a gray scale voltage V64′. The gray scale voltage V64′ is used as gray scale voltage, but the non gray scale voltages Vnon2 and Vnon3 are not used as gray scale voltages. How the gray scale voltage V64′ is used as gray scale voltage is described later in detail.

Both the non gray scale voltage group Gnon and the mixed voltage group Gmix2 are outputted from the outputting portion OutADD of the outputting means 800. However, the non gray scale voltage group Gnon is outputted from the outputting portion OutADD during the outputting periods Pv of the two frame periods F1 and F2 which are the first half of successive 4 frame periods F1 to F4. The mixed voltage group Gmix1 is outputted from the outputting portion OutADD during the outputting periods Pv of the two frame periods F3 and F4 which are the second half of successive 4 frame periods F1 to F4. The non gray scale voltage Vnon2 of the non gray scale voltage group Gnon is outputted during the odd gray scale period Po and the non gray scale voltage Vnon3 is outputted during the even gray scale period Pe. The non gray scale voltage Vnon3 is defined so as to be smaller than the non gray scale voltage Vnon2 by ΔV. The non gray scale voltage V2 of the mixed voltage group Gmix2 is outputted during the odd gray scale period Po and the gray scale voltage V64′ is outputted during the even gray scale period Pe. The gray scale voltage V64′ is defined so as to be larger than the non gray scale voltage Vnon2 by ΔV.

It is noted that the power supply circuit 80 outputs the voltage groups G1 and Gnon during two frame periods F1 and F2 of the first half, but outputs the voltage groups Gmix1 and Gmix2 during two frame periods F3 and F4 of the second half FIGS. 8 and 9 are explained below while being broken down into two cases; one case is two frame periods F1 and F2 of the first half during which the power circuit 80 outputs the voltage groups G1 and Gnon and the other case is two frame periods F3 and F4 of the second half during which the power circuit 80 outputs the voltage groups Gmix1 and Gmix2.

The generated voltage groups G1 and Gnon from the power supply circuit 80 in two frame periods F1 and F2 of the first half are outputted from the outputting portions Out1 and OutADD of the outputting means 800 and are applied across the resistor chain 81. By applying the voltage groups G1 and Gnon across the resistor chain 81, the resistor chain 81 generates the gray scale voltage groups G2 to G32. The generated gray scale voltage groups G2 to G32 are outputted from the outputting portions Out2 to Out32 of the outputting means 800, respectively. Therefore, the outputting means 800 can output the gray scale voltage groups G1 to G32 from the outputting portions Out1 to Out32, respectively. In the odd gray scale period Po, the gray scale voltage V1 and the non gray scale voltage Vnon2 are applied across the resistor chain 81, so that the resistor chain 81 generates gray scale voltages V3, V5, V61 and V63 between the gray scale voltage V1 and the non gray scale voltage Vnon2. Therefore, 32 gray scale voltages V2n−1 (n is integer between 1 and 32 inclusive) of odd levels and the non gray scale voltage Vnon2 are outputted from the outputting portions Out1 to Out32 and OutADD of the outputting means 800. It is noted that the values of the gray scale voltage V1 and the non gray scale voltage Vnon2 and the values of resistors R1 to R32 of the resistor chain 81 are selected in such a way that each of 32 gray scale voltages V2n−1 of odd levels accords with its own ideal gray scale voltage.

On the other hand, in the even gray scale period Pe, the gray scale voltage V2 and the non gray scale voltage Vnon3 are applied across the resistor chain 81, so that the resistor chain 81 generates gray scale voltages V4, V6, . . . , V62 and V64 between the gray scale voltage V2 and the non gray scale voltage Vnon3. Therefore, 32 gray scale voltages V2n (n is integer between 1 and 32 inclusive) of even levels and the non gray scale voltage Vnon3 are outputted from the outputting portions Out1 to Out32 and OutADD of the outputting means 800.

As described above, the gray scale voltage V2 outputted from the outputting portions Out1 during the even gray scale period Pe is defined so as to be smaller than the gray scale voltage V1 outputted during the odd gray scale period Po by ΔV. The non gray scale voltage Vnon3 outputted from the outputting portions OutADD during the even gray scale period Pe is also defined so as to be smaller than the non gray scale voltage Vnon2 outputted during the odd gray scale period Po by ΔV. Therefore, gray scale voltages outputted from the other outputting portions Out during the even gray scale period Pe are smaller than the gray scale voltages outputted during the odd gray scale period Po by ΔV, respectively. The value ΔV is selected in such a way that the gray scale voltage V32 outputted from the outputting portion Out16 accords with its own ideal gray scale voltage V32i. Therefore, as described with reference to FIG. 7, the gray scale voltages V2n within the region R1 exhibiting the linearity accord with its own ideal gray scale voltages. However, the deviations of the gray scale voltages V2n from its own ideal gray scale voltages are larger within the region R2 exhibiting the non linearity. For example, as shown in FIG. 9, the ideal gray scale voltage V2i of the gray scale voltage V2 is smaller than the gray scale voltage V1 by α, but the actually outputted gray scale voltage V2 during the even gray scale period Pe is smaller than the gray scale voltage V1 by only ΔV, so that the gray scale voltage V2 is larger than the ideal gray scale voltage V2i by ΔV2+. The ideal gray scale voltage V64i of the gray scale voltage V64 is smaller than the gray scale voltage V63 by β, but the actually outputted gray scale voltage V64 during the even gray scale period Pe is smaller than the gray scale voltage V63 by only ΔV, so that the gray scale voltage V64 is larger than the ideal gray scale voltage V64i by ΔV64+.

Therefore, in two frame periods F1 and F2 of the first half, 32 gray scale voltages V2n−1 (n is integer between 1 to 32 inclusive) of odd levels and the gray scale voltages V2n of even levels within the region R1 exhibiting the linearity accord with its own ideal gray scale voltages substantially. However, the gray scale voltages V2n within the region R2 exhibiting the non linearity are larger than its own ideal gray scale voltages.

Next, two frame periods F3 and F4 of the second half during which the power circuit 80 outputs the voltage groups Gmix1 and Gmix2 are discussed.

The generated voltage groups Gmix1 and Gmix2 (see FIGS. 8 and 9) from the power supply circuit 80 in two frame periods F3 and F4 of the second half are outputted from the outputting portions Out1 and OutADD of the outputting means 800 and are applied across the resistor chain 81. By applying the voltage groups Gmix1 and Gmix2 across the resistor chain 81, the resistor chain 81 generates the gray scale voltage groups G2′ to G32′. The generated gray scale voltage groups G2′ to G32′ are outputted from the outputting portions Out2 to Out32 of the outputting means 800. Therefore, the outputting means 800 can output the voltage groups Gmix1 to G32′ from the outputting portions Out1 to Out32 and output the voltage group Gmix2 from the outputting OutADD. In the odd gray scale periods Po of the two frame periods F3 and F4 of the second half, the gray scale voltage V1 and the non gray scale voltage Vnon2 are applied across the resistor chain 81 just as in the case of the two frame periods F1 and F2 of the first half, so that the resistor chain 81 generates gray scale voltages V3, V5, . . . , V61 and V63 between the gray scale voltage V1 and the non gray scale voltage Vnon2.

On the other hand, in the even gray scale period Pe, the non gray scale voltage Vnon1 and the gray scale voltage V64′ are applied across the resistor chain 81, so that the resistor chain 81 generates gray scale voltages V2′, V4′, . . . , V60′ and V62′ between the non gray scale voltage Vnon1 and the gray scale voltage V64′. Therefore, the non gray scale voltage Vnon1 and 32 gray scale voltages V2n′ (n is integer between 1 and 32 inclusive) of even levels are outputted from the outputting portions Out1 to Out32 and OutADD of the outputting means 800.

As described above, in the two frame periods F3 and F4 of the second half, the non gray scale voltage Vnon1 outputted from the outputting portions Out1 during the even gray scale period Pe is defined so as to be larger than the gray scale voltage V1 outputted during the odd gray scale period Po by ΔV, and the gray scale voltage V64′ outputted from the outputting portions OutADD during the even gray scale period Pe is also defined so as to be larger than the non gray scale voltage Vnon2 outputted during the odd gray scale period Po by ΔV. As a result, gray scale voltages outputted from the other outputting portions Out during the even gray scale period Pe are larger than the gray scale voltages outputted during the odd gray scale period Po by ΔV, respectively. Therefore, it is noted that the voltages outputted during the even gray scale period Pe is smaller than the voltages outputted during the odd gray scale period Po by ΔV in the two frame periods F1 and F2 of the first half, but is larger by ΔV in the two frame periods F3 and F4 of the second half

In the two frame periods F3 and F4 of the second half, the value of ΔV is selected in such a way that the gray scale voltage V32′ outputted from the outputting portion Out17 accords with the ideal gray scale voltage V32i. Therefore, as described with reference to FIG. 7, the gray scale voltages V2n′ within the region R1 exhibiting the linearity accord with its own ideal gray scale voltages. However, the deviations of the gray scale voltages V2n′ from its own ideal gray scale voltages are larger within the region R2 exhibiting the non linearity. For example, as shown in FIG. 9, the ideal gray scale voltage V2i of the gray scale voltage V2′ is larger than the gray scale voltage V3 by γ, but the actually outputted gray scale voltage V2′ during the even gray scale period Pe is larger than the gray scale voltage V3 by only ΔV, so that the gray scale voltage V2′ is smaller than the ideal gray scale voltage V2i by ΔV2−. The ideal gray scale voltage V64i of the gray scale voltage V64′ is larger than the non gray scale voltage Vnon2 by δ, but the actually outputted gray scale voltage V64′ during the even gray scale period Pe is larger than the non gray scale voltage Vnon2 by only ΔV, so that the gray scale voltage V64′ is smaller than the ideal gray scale voltage V64i by ΔV64−.

Therefore, in two frame periods F3 and F4 of the second half, 32 gray scale voltages V2n−1 (n is integer between 1 to 32 inclusive) of odd levels and the gray scale voltages V2n′ of even levels within the region R1 exhibiting the linearity accord with its own ideal gray scale voltages substantially. However, the gray scale voltages V2n′ within the region R2 exhibiting the non linearity are smaller than its own ideal gray scale voltages.

The outputting means 800 shown in FIG. 8 is constructed so as to output such voltages described above over successive 4 frame periods F1 to F4.

The outputting device 6 shown in FIG. 8 is provided with an image signal processing circuit 82 for processing the image signal Si having a plurality of image data. The image signal processing circuit 82 comprises a inputting portion 82a for receiving the image signal Si of 6 bits, a first outputting portion 82b for outputting an outputting signal Si′ having the same bit width as the image signal Si of 6 bits, and a second outputting portion 82c for outputting an switching control signal Sc having a bit width of 1 bit. If the least significant bit of the image data inputted to the image signal processing circuit 82 is ‘0’, the image signal processing circuit 82 outputs the outputting signal Si′ having the same bit pattern as the inputted image data from the first outputting portion 82b and outputs the switching control signal Sc of ‘0’ from the second outputting portion 82c.

On the other hand, if the least significant bit of the image data inputted to the image signal processing circuit 82 is ‘1’, the image signal processing circuit 82 processes the image data as described below depending on whether which of the 4 frame periods F1 to F4 the image data corresponds to.

If the image data having the least significant bit ‘1’ corresponds to the frame periods F1 or F2 of the first half of 4 frame periods F1 to F4, the image signal processing circuit 82 outputs the outputting signal Si′ having the same bit pattern as the inputted image data from the first outputting portion 82b and outputs the switching control signal Sc of ‘0’ from the second outputting portion 82c.

However, if the image data having the least significant bit ‘1’ corresponds to the frame periods F3 or F4 of the second half, the image signal processing circuit 82 outputs the image data to which ‘10’ has been added as the outputting signal Si′ from the first outputting portion 82b and outputs the switching control signal Sc of ‘0’ from the second outputting portion 82c. For example, if the image data is “000001”, the first outputting portion 82b outputs the outputting signal Si′ of changed bit pattern “000011”. However, it is noted that if the image data is “111111”, the first outputting portion 82b outputs “000000” as the outputting signal Si′ and the second outputting portion 82c outputs the switching control signal Sc of ‘1’.

The outputting device 6 is provided with a selector 83. The selector 83 is provided with 32 gray scale voltage group inputting portions In1 to In32 which correspond to 32 Out1 to Out32 of 33 outputting portions Out1 to OutADD of the outputting means 800. Therefore, it is noted that the outputted voltages from the outputting portions Out1 to Out32 of the outputting means 800 are inputted to the corresponding inputting portions In1 to In32 of the selector 83, but the outputted voltages from the outputting portion OutADD of the outputting means 800 are not inputted to the selector 83. The selector 83 receives a higher order bits signal Sf′ representing a higher order 5 bits FHB which contains a most significant bit MSB of 6 bits outputting signal Si′ outputted from the image signal processing circuit 82. The selector 83 selects one of 32 inputting portions In1 to In32 corresponding to a bit pattern of the higher order 5 bits represented by the higher order bits signal Sf′ and then outputs the voltage group inputted to the selected inputting portion from the outputting portion 83a. Since the higher order bits signal Sf′ can take 32 (=25) bit patterns, the selector 83 is allowed to select each of 32 inputting portions In1 to In32 in accordance with the bit pattern of the higher order 5 bits represented by the higher order bits signal Sf′.

The outputting device 6 is provided with a connection switching portion 84 and a switch 85. The connection switching portion 84 is controlled by the outputted switching control signal Sc from the outputting portion 82c of the image signal processing circuit 82. The switch 85 is controlled by the least significant bit signal Slsb′ representing the least significant bit LSB of the outputting signal Si′ outputted from the outputting portion 82b of the image signal processing circuit 82. The connection switching portion 84 operates so as to connect the outputting portion 83a of the selector 83 to the switch 85 if the switching control signal Sc is ‘0’ and to connect the outputting portion OutADD of the outputting means 800 to the switch 85 if the switching control signal Sc is ‘1’. The switch 85 switches whether the outputting portion 83a of the selector 83 or the outputting portion OutADD of the outputting means 800, which has been connected to the switch 85 through the connection switching portion 84, should be connected to the video line 5. If the least significant bit signal Slsb′ is ‘1’, the switch 85 is in the closed state during the outputting period Pv. On the other hand, if the least significant bit signal Slsb′ is ‘0’, the switch 85 is in the closed state during the odd gray scale period Po of the outputting period Pv, but is in the open state the even gray scale period Pe.

The outputting device 6 is constructed as described above.

The operation of the outputting device 6 is described in detail. In the description of this operation, the operations of the outputting device 6 in two cases (1) and (2) are taken up: one case (1) in which the image corresponding to the image data “011110” is displayed on the display portion 2 and the other case (2) in which the image corresponding to the image data “000001” is displayed on the display portion 2.

(1) The case in which the image corresponding to the image data “011110” is displayed on the display portion 2

In this case, the outputting device 6 operates during 4 frame periods F1 to F4 as described below.

During the first frame period F1 of 4 frame periods F1 to F4, the outputting means 800 outputs the gray scale voltage groups G1 to G32 from the outputting portions Out1 to Out32 and outputs the non gray scale voltage group Gnon from the outputting portion OutADD. It is again noted that the outputted gray scale voltage groups G1 to G32 from the outputting portions Out1 to Out32 are inputted to the inputting portions In1 to In32 of the selector 83, but the outputted non gray scale voltage group Gnon from the outputting portion OutADD is not inputted to the selector 83. The image data “011110” is inputted to the image signal processing circuit 82. Since the least significant bit of the image data is “0”, the image signal processing circuit 82 outputs the outputting signal Si′ having the same bit pattern as the inputted image data “011110” from the first outputting portion 82b and outputs the switching control signal Sc of ‘0’ from the second outputting portion 82c. The selector 83 receives the signal Sf′ representing the higher order 5 bits FHB “01111” of the outputting signal Si′ ‘011110’. The selector 83 selects the inputting portion In16, which corresponds to the bit pattern ‘0111’ of the higher order 5 bits, of 32 inputting portions In1 to In32. Therefore, the selector 83 outputs the gray scale voltage group G16 inputted to the selected inputting portion In16 from the outputting portion 83a. Since the gray scale voltage group G16 is the gray scale voltage V31 during the odd gray scale period Po as shown in FIG. 9, the selector 83 outputs the gray scale voltage V31 during the odd gray scale period Po from the outputting potion 83a. When the transition from the odd gray scale period Po to the even gray scale period Pe is made, the gray scale voltage group G16 is changed from the gray scale voltage V31 to V32, so that the selector 83 outputs the gray scale voltage V32 from the outputting portion 83a.

Since the outputted switching control signal Sc from the second outputting portion 82c of the image signal processing circuit 82 is ‘0’, the connection switching portion 84 is closed at the side of the selector 83. Therefore, the outputted non gray scale voltage group Gnon from the outputting portion OutADD of the outputting means 800 is not supplied to the switch 85, but the outputted gray scale voltage group G16 from the selector 83 is supplied to the switch 85.

Since the outputting signal Si′ outputted from the image signal processing circuit 82 is “011110”, the least significant bit signal Slsb′ is ‘0’. Therefore, the switch 85 is in the closed state during the odd gray scale period Po of the outputting period Pv but is in the open state during the even gray scale period Pe. As a result, the gray scale voltage V31 outputted from the selector 83 during the odd gray scale period Po is supplied to the video line 5 via the switch 85, but the gray scale voltage V32 outputted from the selector 83 during the even gray scale period Pe is not supplied to the video line 5 since the switch 85 is opened. Therefore, if the image signal Si is “011110”, the selector 83 outputs the both gray scale voltages V31 and V32, but only gray scale voltage V31 is supplied to the video line 5. The gray scale voltage V31 supplied to the video line 5 is supplied to the source bus Bs via the source driver 4 during the selection period Ps. Therefore, the gray scale voltage V31 is supplied to the source bus Bs during the selection period Ps for the source bus Bs. The gray scale voltage V31 supplied to the source bus Bs is supplied to the pixel of the display portion 2 selected by the gate bus Bg. Since the gray scale voltage V31 accords with its own ideal gray scale voltage as described above, the display portion 2 can display the image having a good quality.

The above description is given to the operation of the outputting device 6 during the first frame period F1 of 4 frame periods F1 to F4, but the similar description is given to the operation of the outputting device 6 during the next frame period F2, so that the display portion 2 can display the image having a good quality.

Next, the frame periods F3 and F4 of the second half are discussed. The image signal processing circuit 82 receives the image signal Si of “011110” just as in the case of the frame periods F1 and F2 of the first half. Therefore, the selector 83 selects the inputting potion In16. It is noted that, as shown in FIG. 9, the voltages outputted from the outputting means 800 during the odd gray scale periods Po of the frame periods F3 and F4 of the second half are the same voltages as the odd gray scale periods Po of the frame periods F1 to F2 of the first half, on the other hand, the voltages outputted from the outputting means 800 during the even gray scale periods Pe of the frame periods F3 and F4 of the second half are different from the voltages outputted during the even gray scale periods Pe of the frame periods F1 to F2 of the first half. Namely, the selector 83 outputs the gray scale voltages V31 and V32 during the frame periods F1 and F2 of the first half, but outputs the gray scale voltages V31 and V30′ during the frame periods F3 and F4 of the second half However, since the signal Slsb′ supplied to the switch 85 is ‘0’ just as in the case of the frame periods F1 and F2 of the first half, the switch 85 is opened during the even gray scale period Pe, so that the gray scale voltage V31 is outputted to the video line 5, but the gray scale voltage V30′ is not outputted to the video line 5. Therefore, the display portion 2 is supplied with the gray scale voltage V31 corresponding to the image data “011110”. The gray scale voltage V31 accords with its own ideal gray scale voltage as described above, the display portion 2 can display the image having a good quality during the frame periods F3 and F4 of the second half as well.

Therefore, the display portion 2 can display the image having a good quality over successive 4 frame periods F1 to F4.

The above description is given to the image signal “011110”. In the case of the other image data “xxxxx0” (x is ‘0’ or ‘1’) having the lease significant bit ‘0’, the inputting portion selected by the selector 83 is different, but the other operation is described just as in the case of the image data “011110”.

(2) The case in which the image corresponding to the image data “011111” is displayed on the display portion 2

In this case, the outputting device 6 operates during 4 frame periods F1 to F4 as described below.

During the first frame period F1 of 4 frame periods F1 to F4, the gray scale voltage groups G1 to G32 from the outputting portions Out1 to Out32 of the outputting means 800 are inputted to the inputting portions In1 to In32 of the selector 83, respectively. The image data “011111” is inputted to the image signal processing circuit 82. The image signal processing circuit 82 outputs the outputting signal Si′ having the same bit pattern “011111” as the inputted image data from the first outputting portion 82b and outputs the switching control signal Sc of ‘0’ from the second outputting portion 82c. The selector 83 receives the signal Sf′ representing the higher order 5 bits FHB “01111” of the outputting signal Si′ ‘011111’. The selector 83 selects inputting portion In16, which corresponds to the higher order 5 bits ‘01111’, of 32 inputting portions In1 to In32. Therefore, the selector 83 outputs the gray scale voltage V31 during the odd gray scale period Po and outputs the gray scale voltage V32 during the even gray scale period Pe as shown in FIG. 9.

Since the outputted switching control signal Sc from the second outputting portion 82c of the image signal processing circuit 82 is ‘0’, the connection switching portion 84 is closed at the side of the selector 83. Therefore, the outputted non gray scale voltage group Gnon from the outputting portion OutADD of the outputting means 800 is not supplied to the switch 85, but the outputted gray scale voltage group G16 from the selector 83 is supplied to the switch 85.

Since the outputting signal Si′ outputted from the image signal processing circuit 82 is “000001”, the least significant bit signal Slsb′ is ‘1’. Therefore, the switch 85 is in the closed state over the odd gray scale period Po and the even gray scale period Pe. As a result, the gray scale voltage V1 outputted from the selector 83 is supplied to the video line 5 via the switch 85 and then the gray scale voltage V2 is also supplied to the video line 5. The gray scale voltages V1 and V2 supplied to the video line 5 are supplied to the source bus Bs via the source driver 4 during the selection period Ps. As described with reference to FIG. 9, the gray scale voltages V1 and V2 are outputted from the outputting means 800 during the outputting period Pv corresponding to the selection period Ps for the source bus Bs. Therefore, both gray scale voltages V1 and V2 are supplied to the source bus Bs during the selection period Ps for the source bus Bs. The gray scale voltages V1 and V2 supplied to the source bus Bs are supplied to the pixel of the display portion 2 selected by the gate bus Bg. The pixel is first supplied with V1 of the gray scale voltages V1 and V2 and then supplied with V2. Therefore, the display portion 2 is finally supplied with the gray scale voltage V2.

The above description is given to the operation of the outputting device 6 during the first frame period F1 of 4 frame periods F1 to F4, but the similar description is given to the operation of the outputting device 6 during the next frame period F2, so that the display portion 2 can display the image having a good quality.

Next, the frame periods F3 and F4 of the second half are discussed. The image signal processing circuit 82 receives the image data “011111” just as in the case of the frame periods F1 and F2 of the first half. However, in the case of the frame periods F3 and F4 of the second half, differently to the frame periods F1 and F2 of the first half, ‘10’ is added to the image data “011111”, so that the outputting portion 82b of the image signal processing circuit 82 outputs the outputting signal Si′ of ‘100001’. Therefore, the selector 83 receives the signal Sf′ representing the higher order 5 bits FHB ‘10000’ of the outputting signal Si′ “100001”. The selector 83 selects inputting portion In17, which corresponds to the higher order 5 bits ‘10000’, of 32 inputting potions In1 to In32. As a result, the selector 83 selects the inputting portion In16 in the case of the frame periods F1 and F2 of the first half, but selects the inputting portion In17 in the case of the frame periods F3 and F4 of the second half. However, as shown in FIG. 9, during the frame periods F3 and F4 of the second half, the voltage outputted during the even gray scale period Pe is larger than the voltage outputted during the odd gray scale period Po by ΔV. The gray scale voltage group G17′ outputted from the outputting potion Out17 during frame periods F3 and F4 of the second half is gray scale voltages V33 and V32′ as shown in FIG. 9. Therefore, the selector 83 outputs the gray scale voltage V33 during the odd gray scale period Po, but outputs the gray scale voltage V32′ during the even gray scale period Pe.

The switching control signal Sc of ‘0’ is outputted from the second outputting portion 82c of the image signal processing circuit 82. Therefore, the connection switching portion 84 is closed at the side of the selector 83, so that the mixed voltage group Gmix2 from the outputting portion OutADD of the outputting means 800 is not supplied to the switch 85, but the outputted gray scale voltage group G17′ from the selector 83 is supplied to the switch 85.

Since the outputting signal Si′ outputted from the image signal processing circuit 82 is “100001”, the least significant bit signal Slsb′ is ‘1’. Therefore, the switch 85 is in the closed state over the odd gray scale period Po and the even gray scale period Pe. As a result, the gray scale voltage V33 outputted from the selector 83 is supplied to the video line 5 via the switch 85 and then the gray scale voltage V32′ is also supplied to the video line 5. The gray scale voltages V33 and V32′ supplied to the video line 5 are supplied to the source bus Bs via the source driver 4 during the selection period Ps. As described with reference to FIG. 9, the gray scale voltages V33 and V32′ are outputted from the outputting means 800 during the outputting period Pv corresponding to the selection period Ps for the source bus Bs. Therefore, both gray scale voltages V33 and V32′ are supplied to the source bus Bs during the selection period Ps for the source bus Bs. The gray scale voltages V33 and V32′ supplied to the source bus Bs are supplied to the pixel of the display portion 2 selected by the gate bus Bg. The pixel is first supplied with V33 of the gray scale voltages V33 and V32′ and then supplied with V32′. Therefore, the display portion 2 is finally supplied with the gray scale voltage V32′. Since the gray scale voltage V32′ accords with the ideal gray scale voltage V32i as described above (see FIG. 9), the display portion 2 can display the image having a good quality.

The gray scale voltage V32′ supplied to the video line 5 is supplied to the display portion 2 via the source driver 4. Like the gray scale voltage V32, the gray scale voltage group V32′ accords with the ideal gray scale voltage V32i.

Therefore, the display portion 2 can display the image having a good quality over successive 4 frame periods F1 to F4.

(3) The case in which the image corresponding to the image data “000001” is displayed on the display portion 2

In this case, the outputting device 6 operates during 4 frame periods F1 to F4 as described below.

During the first frame period F1 of 4 frame periods F1 to F4, the gray scale voltage groups G1 to G32 from the outputting portions Out1 to Out32 of the outputting means 800 are inputted to the inputting portions In1 to In32 of the selector 83, respectively. The image data “000001” is inputted to the image signal processing circuit 82. The image signal processing circuit 82 outputs the outputting signal Si′ having the same bit pattern “000001” as the inputted image data from the first outputting portion 82b and outputs the switching control signal Sc of ‘0’ from the second outputting portion 82c. The selector 83 receives the signal Sf′ representing the higher order 5 bits FHB “00000” of the outputting signal Si′ ‘000001’. The selector 83 selects the inputting portion In1, which corresponds to the higher order 5 bits ‘00000’, of 32 inputting portions In1 to In32. Therefore, as shown in FIG. 9, the selector 83 outputs the gray scale voltage V1 during the odd gray scale period Po and outputs the gray scale voltage V2 during the even gray scale period Pe.

Since the outputted switching control signal Sc from the second outputting portion 82c of the image signal processing circuit 82 is ‘0’, the connection switching portion 84 is closed at the side of the selector 83. Therefore, the outputted non gray scale voltage group Gnon from the outputting portion OutADD of the outputting means 800 is not supplied to the switch 85, but the outputted gray scale voltage group G16 from the selector 83 is supplied to the switch 85.

Since the outputting signal Si′ outputted from the image signal processing circuit 82 is “000001”, the least significant bit signal Slsb′ is ‘1’. Therefore, the switch 85 is in the closed state over the odd gray scale period Po and the even gray scale period Pe. As a result, the gray scale voltage V1 outputted from the selector 83 is supplied to the video line 5 via the switch 85 and then the gray scale voltage V2 is also supplied to the video line 5. The gray scale voltages V1 and V2 supplied to the video line 5 are supplied to the source bus Bs via the source driver 4 during the selection period Ps. As described with reference to FIG. 9, the gray scale voltages V1 and V2 are outputted from the outputting means 800 during the outputting period Pv corresponding to the selection period Ps for the source bus Bs. Therefore, both gray scale voltages V1 and V2 are supplied to the source bus Bs during the selection period Ps for the source bus Bs. The gray scale voltages V1 and V2 supplied to the source bus Bs are supplied to the pixel of the display portion 2 selected by the gate bus Bg. The pixel is first supplied with V1 of the gray scale voltages V1 and V2 and then supplied with V2. Therefore, the display portion 2 is finally supplied with the gray scale voltage V2.

The above description is given to the operation of the outputting device 6 during the first frame period F1 of 4 frame periods F1 to F4, but the similar description is given to the operation of the outputting device 6 during the next frame period F2, so that the display portion 2 is supplied with the gray scale voltage V2.

It is noted that the gray scale voltage V2 supplied to the display portion 2 is larger than the ideal gray scale voltage V2i by ΔV2+ as shown in FIG. 9. Namely, the gray scale voltage V2 dose not accord with the ideal gray scale voltage V2i. Therefore, the quality of the image actually displayed on the display portion 2 is inferior to that of the image displayed on the display portion 2 if the display portion 2 is supplied with the ideal gray scale voltage V2i. In order to improve the quality of the image displayed on the display portion 2, the outputting device 6 shown in FIG. 8 operates during the frame periods F3 and F4 of the second half as described below.

The image signal processing circuit 82 receives the image data “000001”. However, in the case of the frame periods F3 and F4 of the second half differently to the case of the frame periods F1 and F2 of the first half, ‘10’ is added to the image data “000001”, so that the outputting portion 82b of the image signal processing circuit 82 outputs the outputting signal Si′ of ‘000011’. Therefore, the selector 83 receives the signal Sf′ representing the higher order 5 bits FHB ‘00001’ of the outputting signal Si′ “000011”. The selector 83 selects the inputting portion In2, which corresponds to the higher order 5 bits ‘00001’, of 32 inputting potions In1 to In32. As a result, the selector 83 selects the inputting portion In1 in the case of the frame periods F1 and F2 of the first half, but selects the inputting portion In2 in the case of the frame periods F3 and F4 of the second half. However, in the case of the frame periods F3 and F4 of the second half, the voltage outputted during the even gray scale period Pe is larger than the voltage outputted during the odd gray scale period Po by ΔV as shown in FIG. 9, so that the gray scale voltage group G2′ outputted from the outputting potion Out2 during frame periods F3 and F4 of the second half is gray scale voltages V3 and V2′. Therefore, the selector 83 outputs the gray scale voltage V3 during the odd gray scale period Po, but outputs the gray scale voltage V2′ during the even gray scale period Pe.

The switching control signal Sc of ‘0’ is outputted from the second outputting portion 82c of the image signal processing circuit 82. Therefore, the connection switching portion 84 is closed at the side of the selector 83, so that the mixed voltage group Gmix2 from the outputting portion OutADD of the outputting means 800 is not supplied to the switch 85, but the outputted gray scale voltage group G2′ (gray scale voltages V3 and V2′) from the selector 83 is supplied to the switch 85.

Since the outputting signal Si′ outputted from the image signal processing circuit 82 is “000011”, the least significant bit signal Slsb′ is ‘1’. Therefore, the switch 85 is in the closed state over the odd gray scale period Po and the even gray scale period Pe. As a result, the gray scale voltage V3 outputted from the selector 83 is supplied to the video line 5 via the switch 85 and then the gray scale voltage V2′ is also supplied to the video line 5. The gray scale voltages V3 and V2′ supplied to the video line 5 are supplied to the source bus Bs via the source driver 4 during the selection period Ps. As described with reference to FIG. 9, the gray scale voltages V3 and V2′ are outputted from the outputting means 800 during the outputting period Pv corresponding to the selection period Ps for the source bus Bs. Therefore, both the gray scale voltages V3 and V2′ are supplied to the source bus Bs during the selection period Ps for the source bus Bs. The gray scale voltages V3 and V2′ supplied to the source bus Bs are supplied to the pixel of the display portion 2 selected by the gate bus Bg. This pixel is first supplied with V3 of the gray scale voltages V3 and V2′ and then supplied with V2′. Therefore, the display portion 2 is finally supplied with the gray scale voltage V2′.

The gray scale voltage V2′ supplied to the display portion 2 is smaller than the ideal gray scale voltage V2i by ΔV2−. That is to say, the gray scale voltage V2′ does not accord with the ideal gray scale voltage V2i.

However, as described above, the outputting device 6 shown in FIG. 8 outputs the gray scale voltage V2 during two frame periods F1 and F2 of the first half and outputs the gray scale voltage V2′ during two frame periods F3 and F4 of the second half. As shown in FIG. 9, the gray scale voltage V2 is larger than the ideal gray scale voltage V2i by ΔV2+, but the gray scale voltage V2′ is smaller than the ideal gray scale voltage V2i by ΔV2−. Therefore, if 4 frame periods F1 to F4 are considered comprehensively, it can be considered that the display portion 2 is substantially supplied with a mean voltage V2m (see FIG. 9) of the gray scale voltages V2 and V2′. This mean voltage V2m dose not accord with the ideal gray scale voltage V2i, but the difference between the mean voltage V2m and the ideal gray scale voltage V2i is smaller than the difference between the gray scale voltage V2, V2′ and the ideal gray scale voltage V2i. Therefore, the user watching the display portion 2 can realize the image having a higher quality, compared with the case in which the display portion 2 is only supplied with the gray scale voltages V2 or V2′.

In the case described above, two image signals “011111” and “000001” are taken up as the image signal Si having the least significant bit ‘1’, but the other image signal “xxxxx1” can be similarly considered. However, if the image signal Si is “111111”, the outputting device 6 operates little differently to the case described above. The operation of the outputting device 6 in which the image signal Si is “111111” is described below.

The frame periods F1 and F2 of the first half of 4 frame periods F1 to F4 can be considered similarly to the case of the image data “011111” and “000001”. Namely, the selector 83 selects the outputting portion Out32, which corresponds to the higher order 5 bits “11111” of the image data “111111”, of the outputting portions Out1 to Out32 of the outputting means 800. Therefore, the outputting device 6 outputs the gray scale voltages V63 and V64 during the two frame periods F1 and F2 of the first half, so that V63 and V64 are supplied with the video line 5.

The gray scale voltages V63 and V64 supplied to the video line 5 are supplied to the source bus Bs via the source driver 4 during the selection period Ps. The gray scale voltages V63 and V64 supplied to the source bus Bs are supplied to the pixel of the display portion 2 selected by the gate bus Bg. This pixel is first supplied with V63 of the gray scale voltages V63 and V64 and then supplied with V64. Therefore, the display portion 2 is finally supplied with the gray scale voltage V64. It is noted that the gray scale voltage V64 supplied to the display portion 2 is larger than the ideal gray scale voltage V64i by ΔV64+ as shown in FIG. 9. Namely, the gray scale voltage V64 dose not accord with the ideal gray scale voltage V64i. Therefore, the quality of the image actually displayed on the display portion 2 is inferior to that of the image displayed on the display portion 2 if the display portion 2 is supplied with the ideal gray scale voltage V64i. In order to improve the quality of the image displayed on the display portion 2, the outputting device 6 shown in FIG. 8 operates as described below during the frame periods F3 and F4 of the second half

The image signal processing circuit 82 receives the image data “111111”. However, in the case of the frame periods F3 and F4 of the second half differently to the frame periods F1 and F2 of the first half, the image signal processing circuit 82 adds ‘10’ to the inputted image data “111111” to produce 7 bits data “1000001”. The least significant bit ‘1’ of the 7 bits data “1000001” is outputted from the second outputting portion 82c as the switching control signal Sc and the remaining higher order 5 bits ‘100000’ is outputted from the first outputting portion 82b as the outputting signal Si′. The selector 83 is supplied with the signal Sf′ representing the higher order S bits FHB ‘10000’ of the outputting signal Si′ “100000”, and the switch 85 is supplied with the signal Slsb′ representing the least significant bit LSB ‘0’. The connection switching portion 84 is supplied with the switching control signal Sc. Since the switching control signal Sc is ‘1’, the connection switching portion 84 is closed at the side of the outputting portion OutADD of the outputting means 800 instead of the selector 83. Therefore, the switch 85 is supplied with the outputted mixed voltage group Gmix2 from the outputting portion OutADD of the outputting means 800 instead of the outputted voltage from the selector 83.

Since the mixed voltage group Gmix2 is the non gray scale voltage Vnon2 during the odd gray scale period Po as shown in FIG. 9, the outputting portion OutADD of the outputting means 800 outputs the non gray scale voltage Vnon2 to the switch 85 during the odd gray scale period Po. On the other hand, the mixed voltage group Gmix2 changes from the non gray scale voltage Vnon2 to the gray scale voltage V64′ by the transition from the odd gray scale period Po to the even gray scale period Pe, so that the outputting portion OutADD of the outputting means 800 outputs the gray scale voltage V64′ to the switch 85.

Since the outputting signal Si′ outputted from the image signal processing circuit 82 is “000001”, the least significant bit signal Slsb′ is ‘1’. Therefore, the switch 85 is in the closed state over the odd gray scale period Po and the even gray scale period Pe. As a result, the non gray scale voltage Vnon2 outputted from the outputting portion OutADD of the outputting means 800 is supplied to the video line 5 via the switch 85 and then the gray scale voltage V64′ is also supplied to the video line 5. The non gray scale voltage Vnon2 and the gray scale voltage V64′ supplied to the video line 5 are supplied to the source bus Bs via the source driver 4 during the selection period Ps. Therefore, both non gray scale voltage Vnon2 and the gray scale voltage V64′ are supplied to the source bus Bs during the selection period Ps for the source bus Bs. The non gray scale voltages Vnon2 and the gray scale voltage V64′ supplied to the source bus Bs are supplied to the pixel of the display portion 2 selected by the gate bus Bg. This pixel is first supplied with Vnon2 of the non gray scale voltage Vnon2 and the gray scale voltage V64′ and then supplied with V64′. Therefore, the display portion 2 is finally supplied with the gray scale voltage V64′.

The gray scale voltage V64′ supplied to the display portion 2 is smaller than the ideal gray scale voltage V64i by ΔV64−as shown in FIG. 9. Namely, the gray scale voltage V64′ does not accord with the ideal gray scale voltage V64i.

However, as described above, the outputting device 6 shown in FIG. 8 outputs the gray scale voltage V64 during two frame periods F1 and F2 of the first half and outputs the gray scale voltage V64′ during two frame periods F3 and F4 of the second half. As shown in FIG. 9, the gray scale voltage V64 is larger than the ideal gray scale voltage V64i by ΔV64+, but the gray scale voltage V64′ is smaller than the ideal gray scale voltage V64i by ΔV64−. Therefore, if 4 frame periods F1 to F4 are considered comprehensively, it can be considered that the display portion 2 is substantially supplied with a mean voltage V64m of the gray scale voltages V64 and V64′. The mean voltage V64m depends on the gray scale voltage V64′, so that the mean voltage V64m can be accorded with the ideal gray scale voltage V64i by setting the gray scale voltage V64′ to the adequate value. Since the gray scale voltage V64′ depends on the resistance value of the resistor R32 of the resistor chain 81 and the voltage value of the non gray scale voltage Vnon2, the mean voltage V64m can be accorded with the ideal gray scale voltage V64′ by adjusting the resistance value of the resistor R32 and the voltage value of the non gray scale voltage Vnon2. In this case, the value of the non gray scale voltage Vnon2 can not be arbitrarily selected since the value of the non gray scale voltage Vnon2 is selected in such a way that the gray scale voltage V64′ is set to the adequate value described above. However, it is noted that the quality of the image displayed on the display portion 2 is not affected by the selected value of the non gray scale voltage Vnon2 since the non gray scale voltage Vnon2 is not used as the gray scale voltage.

When the outputting device 6 shown in FIG. 8 displays the image corresponding to the image data having the least significant bit ‘x1’, the selector 83 changes inputting portion to be selected from the inputting portions In1 to In32 between the frame periods of the first half (F1 and F2) and the frame periods of the second half (F3 and F4). Further, if the image corresponding to the image data “111111” is displayed, the connection switching portion 84 switches whether the switch 85 should be connected to the outputting portion 83a of the selector 83 or the outputting portion OutADD of the outputting means 800 between the frame periods of the first half (F1 and F2) and the second half (F3 and F4). Such operation of the selector 83 and the connection switching portion 84 makes it possible to display the 64-level gray scale image with higher quality on the display portion 2.

As described above, the use of the outputting device 6 shown in FIG. 8 makes it possible to display the 64-level gray scale image with higher quality on the display portion 2, but the number of the outputting portions of the outputting means 800 is only 33, so that the miniaturization of the outputting means 800 is achieved.

Since the total number of the inputting portions In1 to In32 required in the selector 83 is 32, the number of the switches required in the selector 83 for the purpose of the switching between the inputting portions In1 to In32 is also only 32, so that the miniaturization of the selector 83 is achieved.

In third embodiment, the voltage groups G1 to G32 and others outputted from the outputting means 800 are outputted during two frame periods F1 and F2 of the first half, and the voltage groups G2′ to G32′ and others are outputted during two frame periods F3 and F4 of the second half. Namely, the outputting means 800 alternatively outputs the voltage groups G1 to G32 and others and the voltage groups G2′ to G32′ and others every two frame periods. However, it is noted that the voltage groups G1 to G32 and others and the voltage groups G2′ to G32′ and others may be alternatively outputted every one frame period or every three or more frame periods.

In the outputting device 6 of the three embodiments described above (see FIGS. 2, 4 and 8), the gray scale voltage V2n−1 of the odd level is first outputted and then the gray scale voltage V2n of the even level is outputted during the outputting period Pv (see FIGS. 3, 6 and 9). However, the gray scale voltage V2n of the even level may be first outputted and then the gray scale voltage V2n−1 of the odd level may be outputted.

Each of the outputting means 600, 700 and 800 in the outputting devices 6 of the three embodiments described above outputs two gray scale voltages from one outputting portion Out during the outputting period Pv. However, it is possible to output three or more gray scale voltages from one outputting portion Out in the present invention. In this case, it is possible to further miniaturize the outputting device 6.

As described above, the miniaturized gray scale voltage outputting device is obtained according to the present invention.

1. A gray scale voltage outputting device for outputting gray scale voltages in response to an image signal having a plurality of image data,
wherein said device comprises a first selecting means, having a plurality of first inputting portions for receiving a plurality of gray scale voltage groups each of which has a plurality of gray scale voltages, for selecting one of said received plurality of gray scale voltage groups,
and wherein said device outputs one or more gray scale voltages of said plurality of gray scale voltages of said selected gray scale voltage group.

2. A gray scale voltage outputting device as claimed in claim 1,
wherein said device comprises a first outputting means having a plurality of first outputting portions for outputting said plurality of gray scale voltage groups to said plurality of first inputting portions of said first selecting means during a first predetermined period.

3. A gray scale voltage outputting device as claimed in claim 2,
wherein said first outputting means comprises a generating means for generating said plurality of gray scale voltage groups,
and wherein said generated plurality of gray scale voltage groups are outputted from said plurality of first outputting portions of said first outputting means during said first predetermined period.

4. A gray scale voltage outputting device as claimed in claim 3,
wherein said image data is represented by a plurality of bits,
and wherein the total number of said gray scale voltages of said generated plurality of gray scale voltage groups is equal to the number of bit patterns which said plurality of bits can take.

5. A gray scale voltage outputting device as claimed in claim 4,
wherein said first selecting means selects one of said received plurality of gray scale voltage groups on the basis of a bit pattern of higher order bits of said plurality of bits, said higher order bits comprising at least the most significant bit of said plurality of bits,
and wherein said device outputs one or more gray scale voltages of said plurality of gray scale voltages of said selected gray scale voltage group on the basis of a bit pattern of lower order bits of said plurality of bits, said lower order bits comprising at least the least significant bit of said plurality of bits.

6. A gray scale voltage outputting device as claimed in claim 2,
wherein said image data is represented by a plurality of bits,
and wherein the total number of said gray scale voltages of said plurality of gray scale voltage groups is smaller than the number of bit patterns which said plurality of bits can take.

7. A gray scale voltage outputting device as claimed in claim 6,
wherein said first outputting means comprises a second selecting means, having a plurality of second inputting portions for receiving a plurality of reference voltage group each of which has a plurality of reference voltages, for selecting two of said received plurality of reference voltage groups,
and wherein said first outputting means outputs said plurality of gray scale voltage groups from said plurality of first outputting portions on the basis of said selected two reference voltage groups.

8. A gray scale voltage outputting device as claimed in claim 7,
wherein said second selecting means selects said two reference voltage groups on the basis of a bit pattern of higher order bits of said plurality of bits, said higher order bits comprising at least the most significant bit of said plurality of bits,
wherein said first selecting means selects one of said received plurality of gray scale voltage groups on the basis of a bit pattern of intermediate order bits of said plurality of bits,
and wherein said device outputs one or more gray scale voltages of said plurality of gray scale voltages of said selected gray scale voltage group on the basis of a bit pattern of lower order bits of said plurality of bits, said lower order bits comprising at least the least significant bit of said plurality of bits.

9. A gray scale voltage outputting device as claimed in claim 7,
wherein at least one of said reference voltage groups is used as said gray scale voltage group.

10. A gray scale voltage outputting device as claimed in claim 7,
wherein said first outputting means comprises a second outputting means having a plurality of second outputting portions for outputting said plurality of reference voltage groups to said plurality of second inputting portions of said second selecting means during a second predetermined period.

11. A gray scale voltage outputting device as claimed in claim 5,
wherein said device comprises a third selecting means for selecting one or more gray scale voltages of said plurality of gray scale voltages of said selected gray scale voltage group.

12. A gray scale voltage outputting device as claimed in claim 11,
wherein said first selecting means sequentially outputs said plurality of gray scale voltages of said selected gray scale voltage group to said third selecting means,
and wherein said third selecting means selects a first gray scale voltage of said plurality of gray scale voltages and dose not select a second gray scale voltage of said plurality of gray scale voltages, said first gray scale voltage corresponding to said bit pattern of said lower order bits and said second gray scale voltage being outputted from said first selecting means after said first gray scale voltage.

13. A gray scale voltage outputting device as claimed in claim 12,
wherein said third selecting means also selects a third gray scale voltage of said plurality of gray scale voltages, said third gray scale voltage being outputted from said first selecting means before said selected first gray scale voltage.

14. A gray scale voltage outputting device as claimed in claim 2,
wherein said first predetermined period comprises a first sub-period and a second sub-period, said first sub-period being for outputting a gray scale voltage corresponding to said image data having the least significant bit of a first logic, said second sub-period being for outputting a gray scale voltage corresponding to said image data having the least significant bit of a second logic.

15. A gray scale voltage outputting device as claimed in claim 14,
wherein said first sub-period precedes said second sub-period,
and wherein said first sub-period is longer than said second sub-period.

16. A gray scale voltage outputting device as claimed in claim 2,
wherein a first gray scale voltage group of said plurality of gray scale voltage group comprises a smaller gray scale voltage than a predetermined ideal gray scale voltage during a first frame period of successive frame periods,
wherein a second gray scale voltage group of said plurality of gray scale voltage group comprises a higher gray scale voltage than said predetermined ideal gray scale voltage during a second frame period of said successive frame periods,
wherein said first selecting means selects said first gray scale voltage group during said first frame period and selects said second gray scale voltage group during said second frame period,
and wherein said device outputs said smaller gray scale voltage if said first selecting means selects said first gray scale voltage group and outputs said higher gray scale voltage if said first selecting means selects said second gray scale voltage group.

17. A gray scale voltage outputting device as claimed in claim 16,
wherein said device comprises a processing means for processing a series of image data each of which having a predetermined bit pattern,
wherein said processing means outputs said series of image data as a series of outputting data comprising a first outputting data and a second outputting data, said first outputting data having said predetermined bit pattern and said second outputting data having a different bit pattern from said predetermined bit pattern,
and wherein said device outputs said smaller gray scale voltage during said first frame period and outputs said higher gray scale voltage during said second frame period on the basis of said series of outputting data.

18. A gray scale voltage outputting device as claimed in claim 17,
wherein said first selecting means selects one of said first and second gray scale voltage groups on the basis of a bit pattern of higher order bits of a first plurality of bits and selects the other of said first and second gray scale voltage groups on the basis of a bit pattern of higher order bits of a second plurality of bits, said first plurality of bits representing said first outputting data, said second plurality of bits representing said second outputting data.

19. A gray scale voltage outputting device as claimed in claim 17,
wherein a third gray scale voltage group of said plurality of gray scale voltage groups comprises a predetermined gray scale voltage deviating from said predetermined ideal gray scale voltage,
wherein said device comprises an additional voltage outputting means for outputting an additional gray scale voltage deviating from said predetermined ideal gray scale voltage,
wherein one of said predetermined gray scale voltage and said additional gray scale voltage is larger than said predetermined ideal gray scale voltage and the other is smaller than said predetermined ideal gray scale voltage,
and wherein said device outputs said predetermined gray scale voltage during one of said first and second frame periods and outputs said additional gray scale voltage during the other of said first and second frame periods on the basis of said series of outputting data.

20. A gray scale voltage outputting device as claimed in claim 19,
wherein said predetermined gray scale voltage is maximum gray scale voltage or minimum gray scale voltage.

21. A gray scale voltage outputting device as claimed in claim 17
wherein said device comprises a third selecting means for selecting one or more gray scale voltages of said plurality of gray scale voltages of said selected gray scale voltage group.

22. A gray scale voltage outputting device as claimed in claim 21,
wherein said device comprises a connection switching means for switching whether said third selecting means should be connected to said first selecting means or connected to said additional voltage outputting means.

23. A gray scale voltage outputting device as claimed in claim 21,
wherein said first selecting means sequentially outputs said plurality of gray scale voltages of said selected gray scale voltage group to said third selecting means,
and wherein said third selecting means selects first gray scale voltage of said plurality of gray scale voltages and dose not select a second gray scale voltage of said plurality of gray scale voltages, said first gray scale voltage corresponding to said bit pattern of said lower order bits and said second gray scale voltage being outputted from said first selecting means after said first gray scale voltage.

24. A gray scale voltage outputting device as claimed in claim 23,
wherein said third selecting means also selects a third gray scale voltage of said plurality of gray scale voltages, said third gray scale voltage being outputted from said first selecting means before said selected first gray scale voltage.

25. A gray scale voltage outputting device as claimed in claim 16,
wherein said first predetermined period comprises a first sub-period and a second sub-period, said first sub-period being for outputting a gray scale voltage corresponding to said image data having the least significant bit of a first logic, said second sub-period being for outputting a gray scale voltage corresponding to said image data having the least significant bit of a second logic.

26. A gray scale voltage outputting device as claimed in claim 25,
wherein said first sub-period precedes said second sub-period,
and wherein said first sub-period is longer than said second sub-period.

27. A image display device comprising a gray scale voltage outputting device as claimed in claim 1.
